(19) United States
(12) Patent Application Publication
(10) Pub. No.: US 2008/0005209 A1
(43) Pub. Date: Jan. 3, 2008

(54) System, method and apparatus for public key encryption

(76) Inventors: Michael E. Kounavis, Hillsboro, OR (US); Arun Raghunath, Beaverton, OR (US); Seth Abraham, Tempe, AZ (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/479,326

(22) Filed: Jun. 29, 2006

(51) Int. Cl. G06F 15/00

(52) U.S. Cl. 708/200

(57) ABSTRACT

A computer is connected to a memory. The computer operates to execute an encryption program in the memory. The encryption program includes a carry bucket portion to convert notation of a first factor, a second factor and a third factor; an incremental modular multiplication portion operates to calculate a first product between the first converted factor and the second converted factor; a graphical multiplication portion operates to calculate a second product of the first converted factor and the second converted factor and a flexible modular reduction (FMR) portion to reduce a third product between the first converted factor and the second converted factor modulus the third converted factor to generate encryption keys.

### BACKGROUND

1. Field

The embodiments relate to encryption, and in particular to a method, apparatus and system for encrypting operands using modular multiplication, graphical-based multiplication and flexible modular reduction.

2. Description of the Related Art

The Rivest Shamir & Adelman (RSA) algorithm for public key encryption is associated with significant processing cost at session establishment time due to the fact that it involves time consuming modular exponentiation operations. Modular exponentiation is the process of deriving the remainder from the division of a power of the input with a specified divisor. Modular exponentiation is time consuming in RSA implementations because the input, the power and the divisor are large numbers (i.e., they are expressed using many bits). For example, the input, the divisor and the power can be 512 bits long. To accelerate the calculation of modular exponents, RSA implementations deduce the calculation of modular exponents to the calculation of modular products and modular squares.

The RSA algorithm involves the calculation of a modular exponent in both the encryption and decryption processes. For example, on the decrypt side a plaintext P is derived from a ciphertext C as:

P=C^{d} mod N

The divisor N is the product of two prime numbers p and q and the decryption exponent d is the multiplicative inverse of the encryption exponent e mod (p−1)(q−1). Using the Chinese remainder theorem one can show that the decryption process can be deduced to the calculation of two smaller modular exponents:

P=(q⁻¹ mod p)·(C^{d}^{ₚ} mod p−C^{d}^{_{q}} mod q)mod p·q+C^{d}^{_{q}} mod q

where:

dₚ=e⁻¹ mod(p−1)

and

d_{q}=e⁻¹ mod(q−1)

The calculation of each of the two modular exponents on the decrypt side and of the modular exponent on the encrypt side can be deduced to the calculation of a number of modular products and modular squares, using the ‘square-and-multiply’ technique.

To calculate a modular product or a modular square, most RSA implementations use the popular Montgomery algorithm (P. L. Montgomery, Modular Multiplication Without Trial Division, Math. Computation, 44: 519-521, 1985). The Montgomery algorithm is slow, however, because it visits every bit of its input twice and performs 3-4 long operations (i.e., input-wide operations) for every bit of the input. Further, the Montgomery algorithm is also slow because it creates mathematical structure for deriving the remainder easily. The Montgomery algorithm adds the divisor into the input product as many times needed in order for the least half of its input to be zero. In this way the final remainder can be computed after two passes on the input are complete.

The Montgomery algorithm accepts as input two numbers X and Y each of length k in bits and a divisor N and returns the number Z=X·Y ·2^{-k} mod N. In order for the algorithm to work, the numbers N and 2^{k} must be relatively prime. For the derivation of the modular product W=X·Y mod N two Montgomery passes are needed: one for calculating the intermediate number Z=X·Y·2^{-k} mod N and one for calculating the final product Was W=Z·2^{2k}·2^{-k} mod N.

The Karatsuba algorithm (A. Karatsuba and Y. Ofman, Multiplication of Multidigit Numbers on Automata, Soviet Physics—Doklady, 7 (1963), pages 595-596) was proposed in 1962 as an attempt to reduce the number of scalar multiplications required for computing the product of two large numbers. The classic algorithm accepts as input two polynomials of degree equal to 1, i.e., a(x)=a₁x+a₀ and b(x)=b₁x+b₀ and computes their product a(x)b(x)=a₁b₁x²+(a₁b₀+a₀b₁)x+a₀b₀ using three scalar multiplications. This technique is different from the naïve (also called the ‘schoolbook’) way of multiplying polynomials a(x) and b(x) which is to perform 4 scalar multiplications, i.e., find the products a₀b₀, a₀b₁, a₁b₀ and a₁b₁.

Karatsuba showed that you only need to do three scalar multiplications, i.e., you only need to find the products a₁b₁, (a₁+a₀)(b₁+b₀) and a₀b₀. The missing coefficient (a₁b₀+a₀b₁) can be computed as the difference (a₁+a₀)(b₁+b₀)−a₀b₀−a₁b₁ once scalar multiplications are performed. For operands of a larger size, the Karatsuba algorithm is applied recursively.

Karatsuba is not only applicable to polynomials but, also large numbers. Large numbers can be converted to polynomials by substituting any power of 2 with the variable x. One of the most important open problems associated with using Karatsuba is how to apply the algorithm to large numbers without having to lose processing time due to recursion. There are three reasons why recursion is not desirable. First, recursive Karatsuba processes interleave dependent additions with multiplications. As a result, recursive Karatsuba processes cannot take full advantage of any hardware-level parallelism supported by a processor architecture or chipset. Second, because of recursion, intermediate scalar terms produced by recursive Karatsuba need more than one processor word to be represented. Hence, a single scalar multiplication or addition requires more than one processor operation to be realized. Such overhead is significant. Third, recursive Karatsuba incurs the function call overhead.

Cetin Koc et. al. from Oregon Sate University (S. S. Erdem and C. K. Koc. “A less recursive variant of Karatsuba-Ofman algorithm for multiplying operands of size a power of two”, Proceedings, 16th IEEE Symposium on Computer Arithmetic, J.-C. Bajard and M. Schulte, editors, pages 28-35, IEEE Computer Society Press, Santiago de Compostela, Spain, Jun. 15-18, 2003) describes a less recursive variant of Karatsuba where the size of the input operands needs to be a power of 2. This variant, however, still requires recursive invocations and only applies to operands of a particular size.

### BRIEF DESCRIPTION OF THE DRAWINGS

The embodiments are illustrated by way of example, and not by way of limitation, in the figures of the accompanying drawings and in which like reference numerals refer to similar elements and in which:

FIG. 1 illustrates a block diagram of a first portion of an embodiment;

FIG. 2 illustrates a carry bucket notation for embodiments;

FIG. 3 illustrates a second portion of an embodiment;

FIG. 4 illustrates flow of an embodiment of a process illustrating a 4 by 4 example for block 320;

FIG. 5 illustrates an examples of complete graphs;

FIG. 6 illustrates examples of graph isomorphism;

FIG. 7 illustrates graph representations of an embodiment for an 18 by 18 example;

FIG. 8 illustrates a representation of a spanning plane of an embodiment using a local index sequence notation;

FIG. 9 illustrates a representation of spanning planes of an embodiment using a semi-local index sequence and global index notations;

FIG. 10 illustrates an alternative representation of a spanning plane;

FIG. 11 illustrates another example of a 9 by 9 spanning plane;

FIG. 12 illustrates an embodiment representation of edge to spanning edge, and spanning plane mapping;

FIG. 13 illustrates a graphical representation of subtraction generation of an embodiment;

FIG. 14A-B illustrate a block diagram of an algorithm used in block 320;

FIG. 15 illustrates comparison of prior art processes with the algorithm used in block 320; and

FIG. 16 illustrates an embodiment of an apparatus and system.

### DETAILED DESCRIPTION

The embodiments discussed herein generally relate to apparatus, system and method for cryptography. Referring to the figures, exemplary embodiments will now be described. The exemplary embodiments are provided to illustrate the embodiments and should not be construed as limiting the scope of the embodiments.

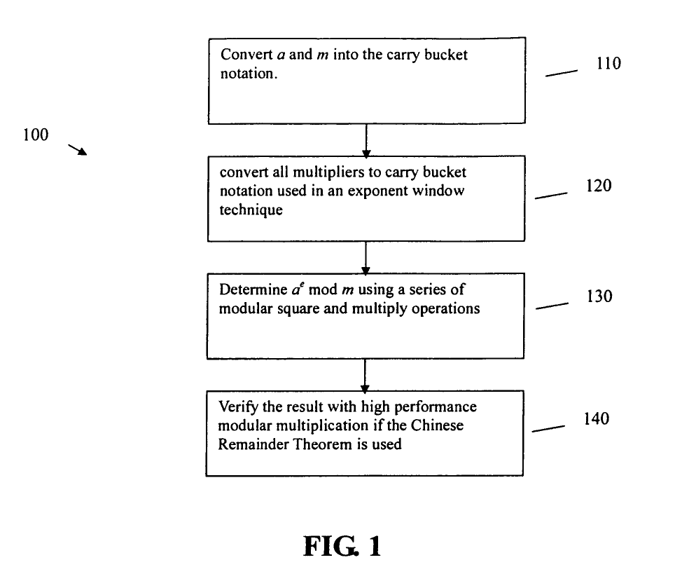

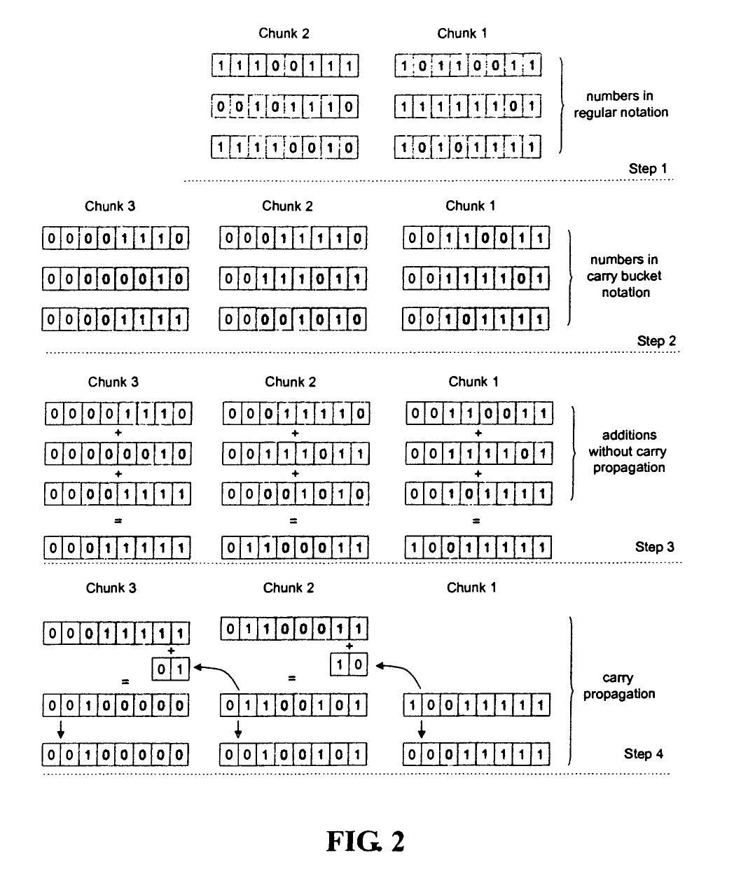

FIG. 1 illustrates a block diagram of a modified embodiment of a Rivest Shamir & Adelman (RSA) process. Process 100 begins with block 10 where input operands (are converted into carry bucket notation, as illustrated in FIG. 2. In this embodiment, a number of most significant bits equal to a carry bucket size are extracted from the first chunk of a large number (i.e., represented by many bits) and placed into the least significant bit positions of the next chunk. The bits of the next chunk are shifted to the left for a number of bit positions equal to the carry bucket size to make room for the new bits that are inserted. This process is repeated for all chunks of a large number. The conversion to the carry bucket notation is illustrated in step 2 of FIG. 2. Once large numbers are converted to the carry-bucket notation dependent additions can be performed.

Before additions are performed the content of all carry buckets is set to zero. When dependent additions are performed on large numbers their corresponding chunks are added to one another without carries being propagated across chunks. The carries, which are being generated during these dependent additions, are accumulated into the carry buckets. In one embodiment the size of each carry bucket is set to the logarithm of the maximum number of dependent additions. In this embodiment, each carry bucket never overflows. Carry propagation takes place once all dependent additions are complete (step 4 in FIG. 2). Carry propagation is done by extracting the bits of every carry bucket and by adding these bits into a next chunk. At the same time the content of every carry bucket is set back to zero. This process is repeated for all chunks of a large number.

In one embodiment conversion to the carry bucket notation takes place only once for all large numbers participating in a multiple precision arithmetic operation, in the beginning of the operation. This property of the carry bucket notation makes the approach convenient for implementing algorithms, such as RSA, which involve a large number of modular squaring and multiplication operations. In one embodiment conversion to the carry bucket notation is performed in the beginning of an embodiment of a modified RSA and not every time a modular multiplication or squaring operation is performed. The overhead from the conversion to the carry bucket notation is negligible.

The carry bucket notation results in an increase in the number of words required for representing a large number. Such increase, however, is usually small, i.e., 1 or 2 words, for numbers between 1-20 chunks. It should be noted that the time cost of converting back and forth between the regular and carry bucket notations is just a few logical SHIFT and AND operations per word.

In one embodiment, an embodiment of a modified RSA process is implemented where the mathematical structure created by the Montgomery algorithm is not necessary for the derivation of the remainder. In this embodiment, instead of creating a new mathematical structure, the mathematical structure which already exists in modular products and which the Montgomery algorithm neglects is exploited.

In one embodiment a dependency exists between two modular products when the second product results from the first by prefixing its input with a few bits. This dependency is used for calculating an incremental modular product when a basic product and an increment are known. The number of long (i.e., input-wide) operations involved in calculating an incremental modular product is just a few. In this embodiment not every bit of the input is visited. Instead, this embodiment calculates a modular product for the least significant half of the input once, and based on this number, it performs incremental updates on the final result visiting only the remaining non-zero most significant bits of the input once.

In one embodiment bit-by-bit incremental modular products are determined. In another embodiment optimization is realized by calculating incremental modular products on a word-by-word basis as opposed to bit-by-bit. Word-by-word determination of incremental modular products also reduces the cache footprint required by the modified RSA. In yet another embodiment, the incremental determination of modular products can be applied to any public key encryption scheme or any key exchange algorithm that uses modular exponentiation and modular products. For example, the determination of incremental modular products can be applied to the acceleration of ElGamal (Taher ElGamal, “A Public-Key Cryptosystem and a Signature Scheme Based on Discrete Logarithms”, IEEE Transactions on Information Theory, v. IT-31, n. 4, 1985, pp 469-472 or CRYPTO 84, pp 10-18, Springer-Verlag), Digital Signature Algorithm (DSA; see U.S. Pat. No. 5,231,668) and the Diffie-Hellman algorithm (New Directions in Cryptography W. Diffie and M. E. Hellman, IEEE Transactions on Information Theory, vol. IT-22, November 1976, pp: 644-654).

In one embodiment, the modified RSA process replaces the Montgomery algorithm and visits only half of the input once. A modular product of the form X·Y mod N can be found in an alternative way, which can be implemented more efficiently than the Montgomery algorithm. The process of incremental modular determination is defined as Incremental Modular Multiplication (IM²) or Products (IMP). In one embodiment it is determined that a mathematical relationship exists between two modular products when the second product results from the first by prefixing its input with a few bits. As a result, if a modular product is known, an incremental modular product can be determined with a few long (i.e., input-wide) operations.

Process 100 continues with block 120 where all multipliers are converted to carry bucket notation if an exponent window technique is used. Next, process 100 continues with block 130 where a^{e} mod m is determined by using a series of modular square and multiply operations are processed. Modular square and multiply operations are determined as follows. Assume that a binary number M is of length m in bits and that another number M⁺ results from M by prefixing M with a single bit equal to 1. Also assume that the modular square M² mod N is known. The modular square M⁺² mod N can be determined from M² mod as follows:

$$\begin{matrix}{M}^{+ 2} \text{mod} N = {( {2}^{m} + M )}^{2} \text{mod} N \\ = ( {2}^{2 m} + {M}^{2} + {2}^{m + 1} M ) \text{mod} N \\ = ( \begin{matrix}{2}^{2 m} \text{mod} N + {M}^{2} \text{mod} N + \\ {2}^{m + 1} \cdot M \text{mod} N\end{matrix} ) \text{mod} N\end{matrix}$$

This shows that the incremental modular square M⁺² mod N can be computed from the modular square M² mod N in a simple manner. In one embodiment, first, the remainder 2^{2m} mod N is pre-computed for all possible values of m and placed in a lookup table. Second, a number congruent to 2^{m+1}·M mod N can be determined in a recursive way with only one long shift operation, one table lookup and one long addition. Next, m is replaced with m+1 and M with M+2^{m} in the expression 2^{m+1}·M to result with:

2^{m+2}(M+2^{m})=2·2^{m+1}·M+2^{2m+2}

Therefore, an incremental modular square requires 2 table lookups, 3 long additions, 1 long shift operation, and 1 modular reduction to complete. In one embodiment the incremental determination of a modular square is done by performing the modular reduction step not on a bit-by-bit basis, but after an aggregate of bits have been taken into account. Thus, the cost of a single modular reduction can be amortized over several calculations. IMP can be further be optimized by storing the tables of pre-computed modular exponents in a fast cache memory unit. In this embodiment, case cache access latencies can be potentially hidden by the time required for other computations to complete. Taking into account all optimizations, the cost of the calculation of a single incremental modular square is approximately 4 long operations, which is similar to the cost of the Montgomery algorithm for a single bit. However, an incremental modular square determination does not need to visit every bit of the input, but only the non-zero most significant half once. In this way it is anticipated that an incremental modular square determination is almost four times faster than the Montgomery algorithm.

An incremental modular product can be calculated in a similar manner as a modular square. First, assume that two numbers X and Y of length m in bits, each for which it the value of the remainder X·Y mod N for some N is known. Also assume that X⁺=2^{m}+X and Y⁺=2^{m}+Y are two increments on X and Y respectively. The incremental modular product X⁺Y⁺ mod N can be determined from XY mod N as follows:

$${X}^{+} \cdot {Y}^{+} \text{mod} N = ( {2}^{m} + X ) \cdot ( {2}^{m} + Y ) \text{mod} N = ( {2}^{2 m} + X \cdot Y + {2}^{m} ( X + Y ) ) \text{mod} N = ( {2}^{2 m} \text{mod} N + X \cdot Y \text{mod} N + {2}^{m} \cdot ( X + Y ) \text{mod} N ) \text{mod} N$$

Therefore, an incremental modular product requires 2 table lookups, 3 long additions, 1 long shift operation, and 1 modular reduction to complete. In one embodiment the incremental calculation of a modular product is optimized by performing the modular reduction step not on a bit-by-bit basis but after an aggregate of bits have been taken into account. Therefore, the cost of a single modular reduction can be amortized over several calculations. In another embodiment, IMP is further optimized by storing the tables of pre-computed modular exponents in a fast cache memory unit. In this case cache access latencies can be potentially hidden by the time required for other computations to complete. Taking into account all optimizations, the cost of the calculation of a single incremental modular product is approximately 4 long operations, which is similar to the cost of the Montgomery algorithm for a single bit. In yet another embodiment the determination of incremental modular products is further optimized to operate on a word-by-word basis as opposed to bit-by-bit.

In one embodiment two binary numbers X and Y are input and the modular product X·Y mod N for some N is returned. Assume that the length of the numbers X, Y and N is the same and is equal to K bits. Also, consider that the input numbers X and Y can be sliced into n slices X₁, X₂, . . . , Xₙ and Y₁, Y₂, . . . , Yₙ such that X=[Xₙ Xₙ₋₁ . . . X₁] and Y=[Yₙ Yₙ₋₁ . . . Y₁]. The length of slices X₁ and Y₁ is l bits, l<K, whereas the length of the slices X₂, . . . , Xₖ and Y₂, . . . , Yₖ is w bits, w<l<K. Obviously K=w·(n−1)+l. Also consider that K>2l. In one embodiment the first step of the framework differs from all subsequent steps. In the first step the process of the framework initializes three variables X⁽¹⁾ Y⁽¹⁾ and P⁽¹⁾ as follows:

X⁽¹⁾=2^{l}·X₁ mod N

Y⁽¹⁾=2^{l}·Y₁ mod N

P⁽¹⁾=X₁·Y₁

In each step k of this framework the process operates on the binary numbers X^{(k-1)} Y^{(k-1)} and P^{(k-1)} produced in the previous step k−1 as follows: the numbers X^{(k)} Y^{(k)} and P^{(k)} are produced from X^{(k-1)} Y^{(k-1)} and P^{(k-1)}:

X^{(k)}=Xₖ·T₁^{(k)}+C₁·X^{(k-1)}

Y^{(k)}=Tₖ·T₁^{(k)}+C₁·Y^{(k-1)}

P^{(k)}=Xₖ·T₂^{(k)}+P^{(k-1)}+Xₖ·Y^{(k-1)}+Yₖ·X^{(k-1)}

The constant value C₁ is equal to 2^{w}. The variable T₁^{(k)} represents the k-th entry of a table T₁. The entries of table T₁ depend on the value of the private key only. Table T₁ is created before the beginning of the encryption process at preprocessing time and contains n K-bit entries. Each value T₁^{(k)} is equal to:

T₁^{(k)}=2^{2·l+(2·k-3)·w} mod N

Similarly, the variable T₂^{(k)} represents the k-th entry of another table T₂. The entries of table T₂ depend on the value of the private key only, like the entries of T₁. Table T₂ is created before the beginning of the encryption process at preprocessing time and contains n K-bit entries. Each value T₂^{(k)} is equal to:

T₂^{(k)}=2^{2·l+(2·k-4)·w} mod N

If k is a multiple of an implementation parameter in, then the numbers X^{(k)} Y^{(k)} and P^{(k)} are reduced mod N:

X^{(k)}←X^{(k)} mod N

X^{(k)}←X^{(k)} mod N

P^{(k)}←P^{(k)} mod N

The parameter in represents the number of steps after which modular reduction is performed on the numbers X^{(k)} Y^{(k)} and P^{(k)}. The embodiment's framework requires a total of n steps to execute. In n/m of these steps modular reduction operations are performed. First assume that in divides n. In the last step n, no X⁽ⁿ⁾ and Y⁽ⁿ⁾ need to be determined. The value P⁽ⁿ⁾ produced in the last step of the framework is the desired remainder:

P⁽ⁿ⁾=X·Y mod N

The number P^{(k)} produced at step k of the framework is congruent (mod N) to the product of two numbers Xₖ^{a} and Yₖ^{a}. The numbers Xₖ^{a} and Yₖ^{a} consist of all slices of X and Y which have been taken into account in steps 1 through k:

P^{(k)}≡Xₖ^{a}·Yₖ^{a}(mod N)

### Where: Xₖ^{a}=[Xₖ Xₖ₋₁ . . . X₁] and: Yₖ^{a}=[Yₖ Yₖ₋₁ . . . Y₁]

A number a is ‘congruent’ to another number b given a specific divisor N if the divisor N divides the difference a−b.

a−b(mod N) [symbol] a−b=c·N for some c

The value P⁽ⁿ⁾ must be congruent to the product X·Y. Since the number P⁽ⁿ⁾ is also reduced mod N in the last step this means that P⁽ⁿ⁾ must be equal to X·Y mod N. To prove this, it is noted that the numbers X^{(k)} and Y^{(k)} produced at step k of the framework are congruent (mod N) to the numbers Xₖ^{a} and Yₖ^{a} respectively, shifted to the left by as many bits as their length:

X^{(k)}≡2^{l+(k-1)·w}·Xₖ^{a}(mod N)

and: Y^{(k)}≡2^{l+(k-1)·w}·Yₖ^{a}(mod N)

Since slices X₁ and Y₁ are l bits long and all other slices X₂, . . . , Xₖ and Y₂, . . . , Yₖ are w bits long, it is evident that l+(k−1)w is the length of the numbers Xₖ^{a} and Yₖ^{a} in bits. This is proved by the following. First, this holds for k=1. Then for some value k*, it also holds for k*+1. For k=1, the proof is straightforward:

X⁽¹⁾=2^{l}·X₁ mod N=2^{l}·X₁^{a} mod N

[symbol]

2^{l}·X₁^{a}−X⁽¹⁾=c·N

[symbol]

X⁽¹⁾≡2^{l}X₁^{a}(mod N)

where c is some integer. The proof for Y⁽¹⁾ is similar. Assume that the above holds for k=k*.

X^{(k*)}≡2^{l+(k*-1)·w}·X_{k*}^{a}(mod N)

[symbol]

X^{(k*)}=2^{l+(k-1)·w}X_{k*}^{a}+c·N

This also holds for k=k*+1.

$$\begin{matrix}{X}^{( {k}^{*} + 1 )} = {X}_{{k}^{*} + 1} \cdot {T}_{1}^{( {k}^{*} + 1 )} + {C}_{1} \cdot {X}^{( {k}^{*} )} \\ = ( from assumption ) {X}_{{k}^{*} + 1} \cdot {T}_{1}^{( {k}^{*} + 1 )} + {C}_{1} \cdot \\ {2}^{l + ( {k}^{*} - 1 ) w} \cdot {X}_{{k}^{*}}^{a} + {C}_{1} \cdot c \cdot N \\ = {2}^{2 l + ( 2 \cdot {k}^{*} - 1 ) \cdot w} \cdot {X}_{{k}^{*} + 1} + {2}^{w} \cdot \\ {2}^{l + ( {k}^{*} - 1 ) \cdot w} \cdot {X}_{{k}^{*}}^{a} + {C}_{2} \cdot N \\ = {2}^{l + {k}^{*} \cdot w} \cdot ( {2}^{l + ( {k}^{*} - 1 ) \cdot w} \cdot {X}_{{k}^{*} + 1} + {X}_{{k}^{*}}^{a} ) + {C}_{2} \cdot N \\ = {2}^{l + {k}^{*} \cdot w} \cdot [ {X}_{{k}^{*} + 1} {X}_{{k}^{*}}^{a} ] + {C}_{2} \cdot N \\ = {2}^{l + {k}^{*} \cdot w} {X}_{{k}^{*} + 1}^{a} + {C}_{2} \cdot N \\ {X}^{( {k}^{*} + 1 )} \\ ≡ {2}^{l + {k}^{*} \cdot w} \cdot {X}_{{k}^{*} + 1}^{a} ( \text{mod} N )\end{matrix}$$

for some integer C₂. The proof for Y^{(k*+1)} is similar. For k=1:

$$\begin{matrix}{P}^{( 1 )} = {X}_{1} \cdot {Y}_{1} = {X}_{1}^{a} \cdot {Y}_{1}^{a} = {X}_{1}^{a} \cdot {Y}_{1}^{a} \\ {X}_{1}^{a} \cdot {Y}_{1}^{a} < N\end{matrix} \} {P}^{( 1 )} ≡ {X}_{1}^{a} \cdot {Y}_{1}^{a} \text{mod} N$$

$${P}^{( {k}^{*} )} ≡ {X}_{{k}^{*}}^{a} \cdot {Y}_{{k}^{*}}^{a} ( \text{mod} N )$$

$${P}^{( {k}^{*} )} = {X}_{{k}^{*}}^{a} \cdot {Y}_{{k}^{*}}^{a} + c \cdot N$$

for some integer constant c. Also,

$$\begin{matrix}{P}^{( {k}^{*} + 1 )} = {X}_{{k}^{*} + 1} \cdot {Y}_{{k}^{*} + 1} \cdot {T}_{2}^{( {k}^{*} + 1 )} + {P}^{( {k}^{*} )} + {X}_{{k}^{*} + 1} \cdot \\ {Y}^{( {k}^{*} )} + {Y}_{{k}^{*} + 1} \cdot {X}^{( {k}^{*} )} \\ = ( from assumption ) {X}_{{k}^{*} + 1} \cdot {Y}_{{k}^{*} + 1} \cdot {T}_{2}^{( {k}^{*} + 1 )} + \\ {X}_{{k}^{*}}^{a} \cdot {Y}_{{k}^{*}}^{a} + {X}_{{k}^{*} + 1} \cdot {Y}^{( {k}^{*} )} + \\ {Y}_{{k}^{*} + 1} \cdot {X}^{( {k}^{*} )} + c \cdot N \\ = {2}^{2 l + ( 2 {k}^{*} - 2 ) \cdot w} \cdot {X}_{{k}^{*} + 1} \cdot {Y}_{{k}^{*} + 1} + \\ {X}_{{k}^{*}}^{a} \cdot {Y}_{{k}^{*}}^{a} + {2}^{l + ( {k}^{*} - 1 ) \cdot w} \cdot {X}_{{k}^{*} + 1} \cdot \\ {Y}_{{k}^{*}}^{a} + {2}^{l + ( {k}^{*} - 1 ) \cdot w} \cdot {Y}_{{k}^{*} + 1} \cdot {X}_{{k}^{*}}^{a} + {C}_{2} \cdot N \\ = ( {2}^{l + ( {k}^{*} - 1 ) \cdot w} \cdot {X}_{{k}^{*} + 1} + {X}_{{k}^{*}}^{a} ) \cdot \\ ( {2}^{l + ( {k}^{*} - 1 ) \cdot w} \cdot {Y}_{{k}^{*} + 1} + {Y}_{{k}^{*}}^{a} ) + {C}_{2} \cdot N \\ = [ {X}_{{k}^{*} + 1} {X}_{{k}^{*}}^{a} ] \cdot [ {Y}_{{k}^{*} + 1} {Y}_{{k}^{*}}^{a} ] + {C}_{2} \cdot N \\ = {X}_{{k}^{*} + 1}^{a} \cdot {Y}_{{k}^{*} + 1}^{a} + {C}_{2} \cdot N\end{matrix}$$

$${P}^{( {k}^{*} )} ≡ {X}_{{k}^{*} + 1}^{a} \cdot {Y}_{{k}^{*} + 1}^{a} ( \text{mod} N )$$

The above embodiment framework requires a total of n steps to execute where:

$$n = \frac{K - l}{w} + 1$$

Here, K is the length of each of the numbers X, Y and N in bits, l is the length of the least significant slices of X and Y and w is the length of all other slices of X and Yin bits. Therefore, by choosing appropriate values for l and w one the number of steps can be set to a desired value.

From the definition of the embodiment framework it is also evident that the calculation of the modular product X·Y mod N is split into two stages. The first stage includes step 1 and requires the calculation of a product between two potentially large numbers X₁ and Y₁. By ‘large’ numbers in this context we mean numbers which length is greater than the maximum length of input operands in a multiplication instruction. The second stage includes all subsequent steps and requires the determination of a number of incremental modular products. It can be seen that in the second stage, at least one argument in each multiplication operation has length no greater than w bits.

In what follows the term ‘scalar’ multiplication is used to refer to a multiplication operation that is implemented as a single instruction in a processor. In one embodiment w is chosen to be equal to the maximum length of input operands in a multiplication instruction. In this embodiment, the number of scalar multiplications required by step one is equal to:

$${N}_{mul}^{( 1 )} = {( \frac{l}{w} )}^{2}$$

Similarly the number of scalar multiplications required for the execution of steps 2-n of the framework is:

$${N}_{mul}^{( 2 , … , n )} = ( n - 1 ) \cdot ( \frac{6 K}{w} + 3 ) = \frac{K - l}{w} \cdot ( \frac{6 K}{w} + 3 )$$

The framework requires the execution of a number of reduction operations as well. The number of modular reductions required is n/m. To determine the number of multiplication and addition operations required for each modular reduction it is necessary to determine the maximum length of the numbers X^{(k)} Y^{(k)} and P^{(k)} in each step of the framework. Assume that log₂(K/w)<<w. If this assumption is correct then after the execution of n steps the numbers X^{(k)} and Y^{(k)} become, in the worst case, K+2w bits long, whereas the number P^{(k)} becomes, in the worst case, K+3w bits long. Using Barrett's algorithm (P. D. Barrett. “Implementing the Rivest Shamir and Adleman public key encryption algorithm on a standard digital signal processor” Advances in Cryptology, Proceedings of Crypto '86, LNCS 263, A. M. Odlyzko, Ed. Springer-Verlag, 1987, pp. 311-323) for modular reduction in the last step of the framework only (i.e., m=n) the number of multiplication operations involved in this reduction operation is:

$${N}_{mul}^{( red )} = 2 \cdot min ( 3 , \frac{K}{w} ) \cdot \frac{K}{w}$$

This is because Barrett's reduction algorithm involves two multiplication operations between large numbers where one operand is at most K+3w bits long and the other operand is K bits long.

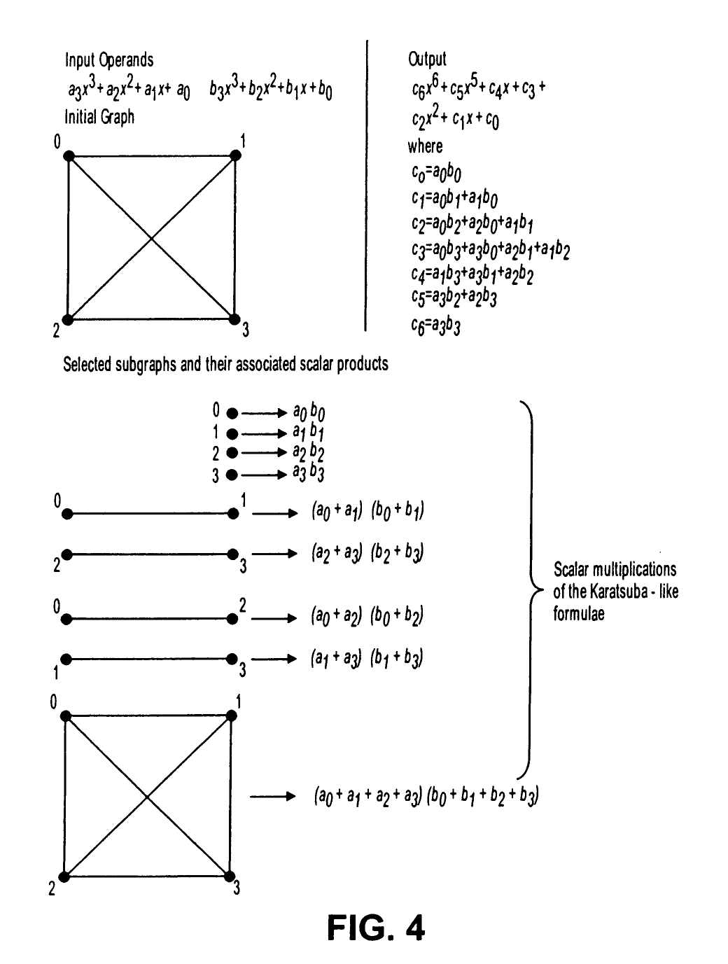

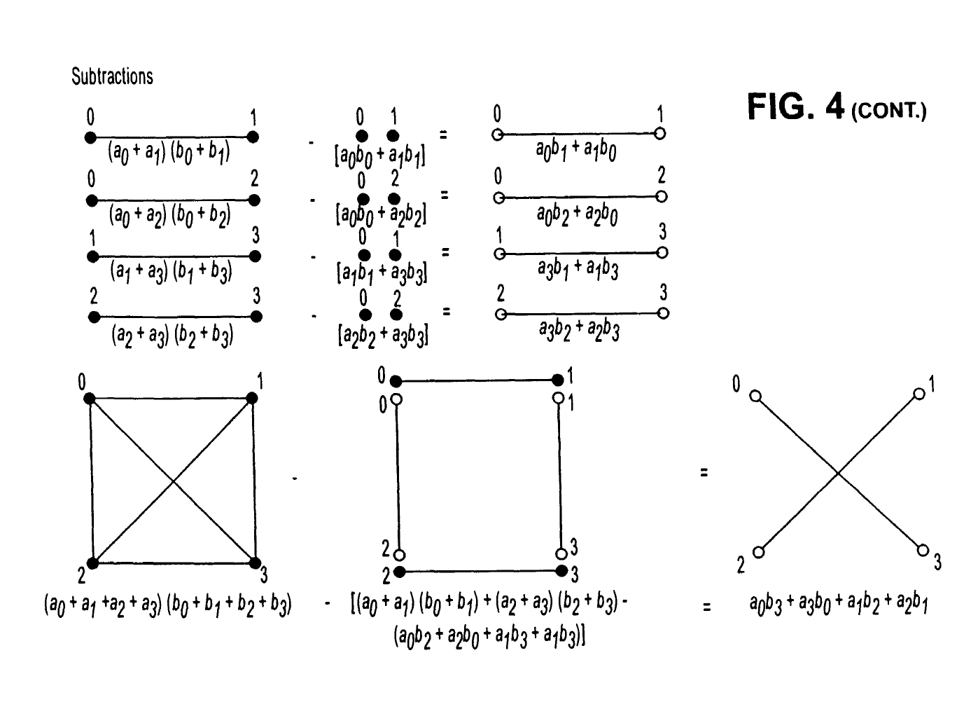

In another embodiment, instead of using Barrett's algorithm, the following flexible modular reduction (FMR) process is used. The FMR process reduces the number of required subtractions as compared to the state of the art. By ‘flexible reduction’ we mean that our process can be implemented using any well known big number multiplication routine. In one embodiment, the process uses the process shown in FIGS. 4-14A-B and described below. This is an advantage over the well known Montgomery reduction algorithm which processes all digits of its input in a serial manner one-by-one. In contrast, our process does not process the input serially but performs two big number multiplications. Each multiplication can be implemented using any functionally correct technique. Our process can be faster or slower than Montgomery depending on the big number multiplication routine used. The benefit of our process as compared to Montgomery comes from the flexibility of its implementation.

In one embodiment division is implemented as multiplication. Instead of dividing a first big number (dividend) with a second one (divisor), the dividend is multiplied with the reciprocal of the divisor. The design of this embodiment reduces the number of subtractions required after the multiplications are complete.

In one embodiment the notation H^{k}(x) and L^{k}(x) are used to denote the k most and least significant bits of number x respectively provided that x is represented with as many bits as its worst case length. One embodiment accepts as input a 2k bit number x and a k bit modulus in equal to:

x=[x₂ₖ₋₁x₂ₖ₋₂ . . . x₀], m=[mₖ₋₁mₖ₋₂ . . . m₀]

where the most significant bits x₂ₖ₋₁ and mₖ₋₁ are not zero. This embodiment also uses a pre-computed value μ equal to the quotient from the division of b^{2k} with m:

$$μ = ⌊ \frac{{b}^{2 k}}{m} ⌋ {b}^{2 k} = μ \cdot m + {r}^{′} , where 0 \leq {r}^{′} < m$$

The remainder r is returned from the division of x with m:

r=x mod m [symbol] x=q·m+r, where 0≦r<m

The first step in one embodiment is to isolate the k+1 most significant bits of x and assign them to a variable q₁.

$${q}_{1} ← {H}^{k + 1} ( x ) = ⌊ \frac{x}{{b}^{k - 1}} ⌋$$

In this embodiment the variable q₁ is multiplied with μ and assigns the result to a second variable q₂.

q₂←q₁·μ

Next, the k most significant bits of the variable q₂ is isolated and these bits are assigned to a third variable q₃.

$${q}_{3} ← {H}^{k} ( {q}_{2} ) = ⌊ \frac{{q}_{2}}{{b}^{k + 1}} ⌋$$

In one embodiment the input number x and the variable q₃ are used for calculating two intermediate terms r₁ and r₂ as follows:

r₁←L^{k+2}(x)=x mod b^{k+2},

r₂←L^{k+2}(q₃·m)=q₃·m mod b^{k+2}

In one embodiment a term R is determined which is equal to:

R←r₁−r₂

Thus, it is proven analytically that the value |r₁−r₂| is between r and 2m+r, where r is the desired remainder. The number of bits required for representing this difference is shown in Table 1.

TABLE 14

| value of \|r₁ − r₂\| | number of bits required |
|---|---|
| r | K |
| m + r | k or k + 1 |
| 2m + r | k + 1 or k + 2 |

To derive r from R, one embodiment checks the k+1 and k+2 least significant bits of R. If they are both zero, then the embodiment process subtracts m from R. If the result is negative, then the embodiment process returns r←R. If the result is positive, then the embodiment process returns r←R−m. If the k+2 least significant bit of R is equal to 1, then the embodiment process subtracts 2m from R and returns r←R−2m. In all these cases so far the embodiment process has performed exactly one subtraction only after the derivation of R. In the case where the k+1 least significant bit of R is equal to 1 and the k+2 bit is equal to zero, the embodiment process performs two subtractions at most. First m is subtracted from R. If the result is negative, then the embodiment process returns r←R. If the result is positive, then the embodiment process further subtracts m from R and returns r←R−2m.

The number of additions required for executing the first step of the embodiment framework is:

$${N}_{add}^{( 1 )} = 2 \cdot {( \frac{l}{w} )}^{2} - 1$$

The number of additions required for executing steps 2-n of the embodiment framework is bounded by:

$${N}_{add}^{( 2 , … , n )} = ( n - 1 ) \cdot \frac{15 K + 8 w}{w} = \frac{K - l}{w} \cdot \frac{15 K + 8 w}{w}$$

The Barrett reduction operation requires, in the worst case, as many additions as needed in order for the multiplication operations to complete and two K bit-wide subtractions. Therefore, the total number of additions and subtractions required for the reduction is:

$${N}_{add}^{( red )} = 2 \cdot min ( 6 \cdot \frac{K}{w} - 2 , 2 {( \frac{K}{w} )}^{2} - 1 ) + 2 \frac{K}{w}$$

Considering that in a particular processor architecture a single multiplication operation requires Cₘᵤₗ cycles to complete, whereas a single addition or subtraction requires C_{add} cycles to complete, the total number of cycles required for the execution of the embodiment framework is:

Cᵢₘₚ=Cₘᵤₗ·(Nₘᵤₗ⁽¹⁾+Nₘᵤₗ^{(2, . . . , n)}+Nₘᵤₗ^{(red)})+C_{add}·(N_{add}⁽¹⁾+N_{add}^{(2, . . . , n)}+N_{add}^{(red)})

Process 100 continues with block 140. In this embodiment, if the Chinese Remainder theory (see e.g., Wagon, S. “The Chinese Remainder Theorem.” §8.4 in Mathematica in Action. New York: W. H. Freeman, pp. 260-263, 1991) is used, the total number of cycles required for modular exponentiation using the square and multiply embodiments with sliding window and the Chinese Remainder Theorem is:

C_{mod}_{_{—}}ₑₓₚ=1.5·K·Cᵢₘₚ

In this embodiment, the result is verified using modular incremental multiplication.

The pseudo code below illustrates the differences between Barrett's algorithm and the above-described embodiments:

### Barrett's Algorithm

INPUT: positive integers x = (x₂ₖ₋₁ ...x1x0)_{b}, m= (mₖ₋₁ ...m1m0)_{b} (with mk−1 ≠ 0), and μ =
[b^{2k}/m] and b>3
OUTPUT: r = x mod m
1. q₁←[x/b^{k-1}], q₂←q₁·μ, q₃←[q₂/b^{k+1}]
2. r₁←x mod b^{k+1}, r₂←q₃·m mod b^{k+1}, r←r₁ − r₂,
3. If r < 0 then r←r + b^{k+1},
4. While r ≧ m do: r←r − m,
5. Return (r)
FMR
INPUT: positive integers x = (x₂ₖ₋₁ ...x1x0)_{b}, m= (mₖ₋₁ ...m1m0)_{b} (with mk−1 ≠ 0), and μ =
[b^{2k}/m] and b=2
OUTPUT: r = x mod m
1. q₁←[x/b^{k-1}], q₂←q₁·μ, q₃←[q₂/b^{k+1}]
2. r₁←x mod b^{k+2}, r₂←q₃·m mod b^{k+1}, r←r₁ − r₂,
3. If rₖ₊₁ = 0 and rₖ₊₂ = 0 then, if r < m return r else return r−m,
4. If rₖ₊₂ = 1 then return r−2m,
5. If rₖ₊₁ = 1 and rₖ₊₂ = 0 then if r < 2m return r−m else return r−2m

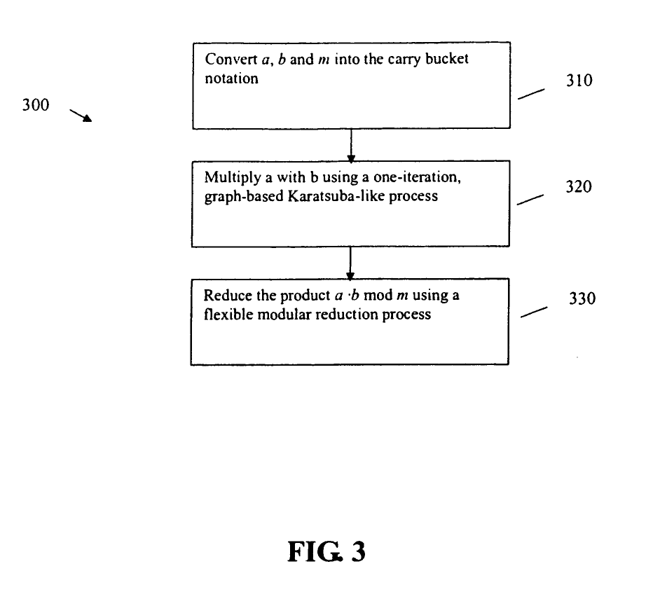

FIG. 3 illustrates an embodiment of an additional process that uses FMR and a graph based single iteration Karatsuba-like process. Process 300 begins with block 310 where a, b and m are converted to carry bucket notation. In this embodiment, the carry bucket size is set to the maximum number of dependent additions. Process 300 continues with block 320 where a is multiplied with b using the following described process illustrated in FIGS. 4-14A-B.

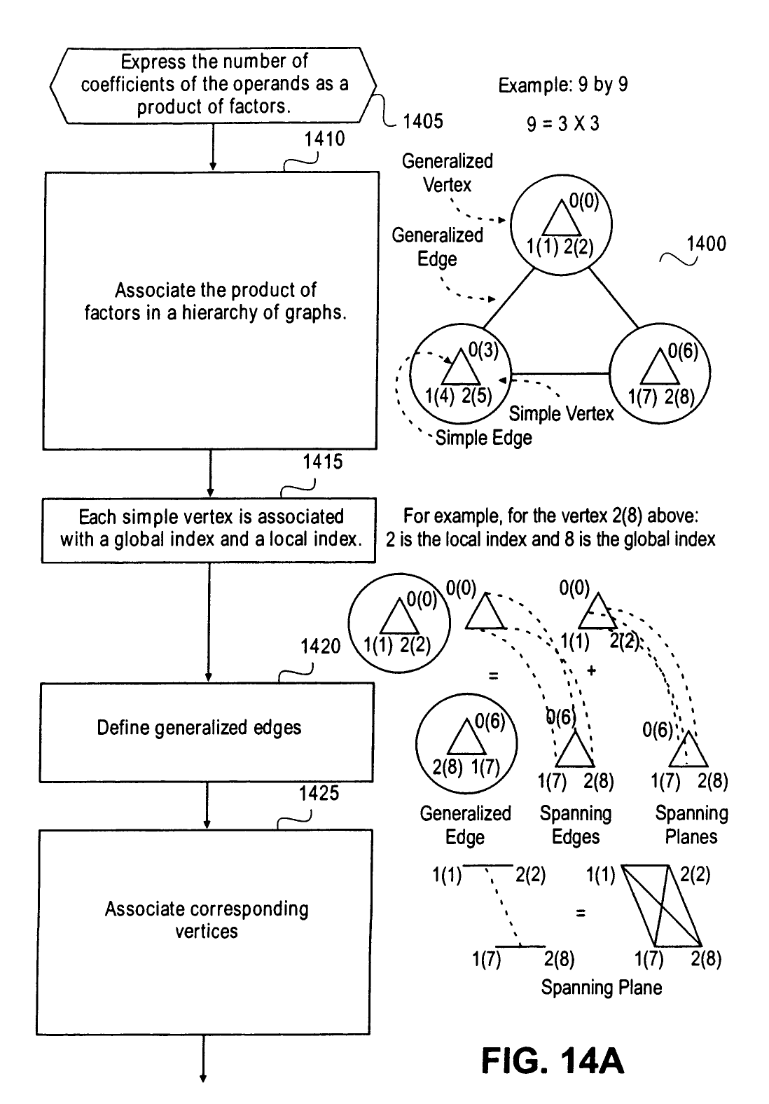

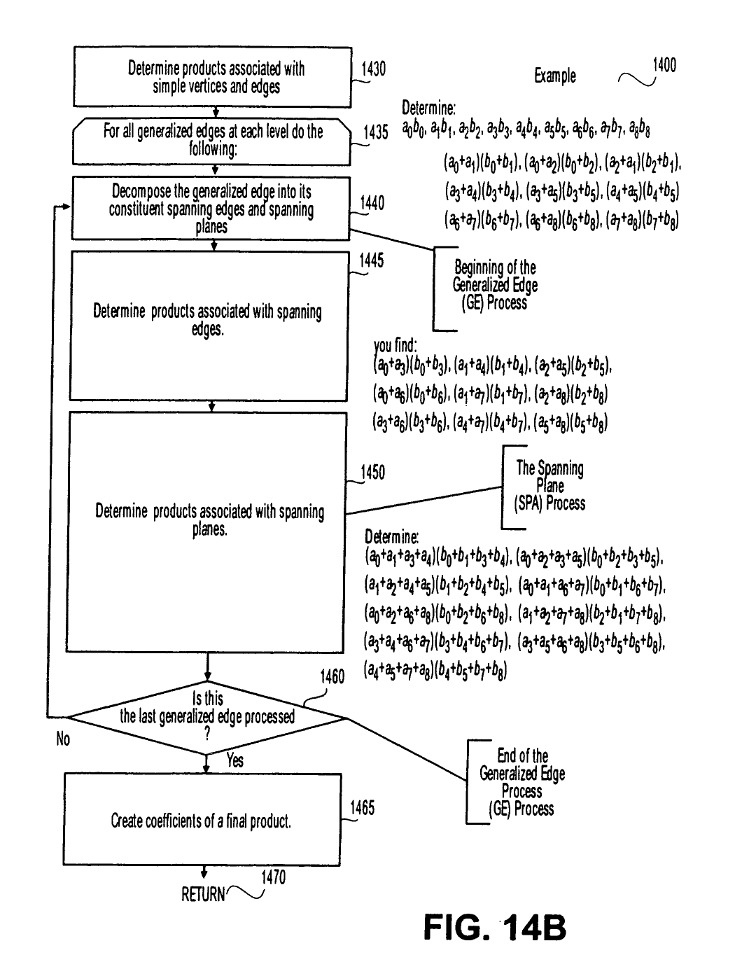

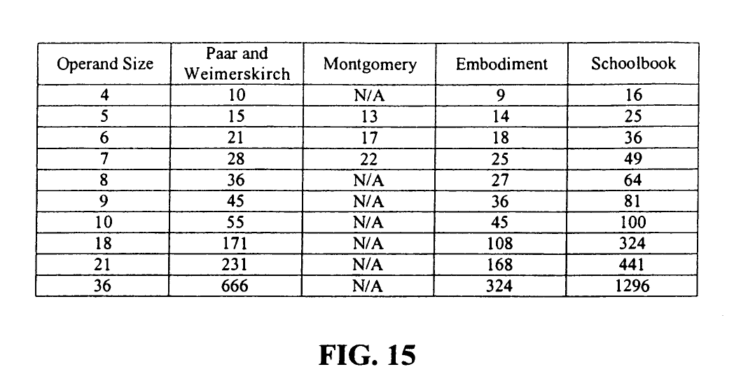

FIG. 4 illustrates an example of generating the terms of a 4 by 4 product using graphs using an embodiment for large number multiplication. As illustrated in FIG. 4 illustrates an example of generating the terms of a 4 by 4 product using graphs using an embodiment. As illustrated in FIG. 4 the input operands are of size 4 words. The operands are the polynomials a(x)=a₃x³+a₂x²+a₁x+a₀ and b(x)=b₃x³+b₂x²+b₁x+b₀. Because of the fact that the input operand size is 4 the embodiment builds a complete square. The vertices of the square are indexed 0, 1, 2, and 3 as illustrated in FIG. 4. The complete square is constructed in a first part of a process of an embodiment (see FIG. 14A). In a second part of a process of an embodiment, a set of complete sub-graphs are selected and each sub-graph is mapped to a scalar product (see FIG. 14B).

A complete sub-graph connecting vertices i₀, i₂, . . . , iₘ₋₁ is mapped to the scalar product (aᵢ_{₀}+aᵢ_{₁}+ . . . +aᵢ_{_{m−1}})·(bᵢ_{₀}+bᵢ_{₁}+ . . . +bᵢ_{_{m−1}}). The complete sub-graphs selected in the example illustrated in FIG. 4 are the vertices 0, 1, 2 and 3, the edges 0-1, 2-3, 0-2 and 1-3, and the entire square 0-1-2-3. The scalar products defined in the second part of the process are a₀b₀, a₁b₁, a₂b₂, a₃b₃, (a₀+a₁)(b₀+b₁), (a₂+a₃)(b₂+b₃), (a₀+a₂)(b₀+b₂), (a₁+a₃)(b₁+b₃), and (a₀+a₁+a₂+a₃)(b₀+b₁+b₂+b₃). In the last part of the process a number of subtractions are performed (see FIG. 14B, 1465).

As an example, the edges 0-1 and 2-3 (with their adjacent vertices), and 0-2 and 1-3 (without their adjacent vertices) are subtracted from the complete square 0-1-2-3. What remains is the diagonals 0-3 and 1-2. These diagonals correspond to the term a₁b₂+a₂b₁+a₃b₀+a₀b₃, which is the coefficient of x³ of the result. In one embodiment the differences produced by the subtractions of sets of formulae represent diagonals of complete graphs where the number of vertices in these graphs is a power of 2 (i.e., squares, cubes, hyper-cubes, etc.). The terms that result from the subtractions, if added to one another, create the coefficients of the final product.

To explain in more detail, the following definitions are first noted. N represents the size of the input (i.e., the number of terms in each input polynomial). N is the product of L integers n₀, n₁, . . . , n_{L-1}. The number L is represents the number of levels of multiplication.

N=n₀·n₁· . . . ·n_{L-1} Eq. 1

For L levels, where a ‘level’ defines a set of complete graphs, the set of graphs of level l is represented as G^{(l)}. The cardinality of the set G^{(l)} is represented as |G^{(l)}|. The i-th element of the set G^{(l)} is represented as Gᵢ^{(l)}. Each set of graphs G^{(l)} has a finite number of elements. The cardinality of the set G^{(l)} is defined as:

$$\vert {G}^{( l )} \vert = \{ \begin{matrix}{\prod }_{i = 0}^{l - 1} {n}_{i} , l > 0 \\ 1 , l = 0\end{matrix} \qquad Eq . 2$$

Each element of the set G^{(l)} is isomorphic to a complete graph Kₙ_{ₗ}. The formal definition of the set of graphs G^{(l)} is illustrated in Eq. 3:

G^{(l)}={Gᵢ^{(l)}:iε[0,|G^{(l)}|−1],Gᵢ^{(l)}≅Kₙ_{ₗ}} Eq. 3

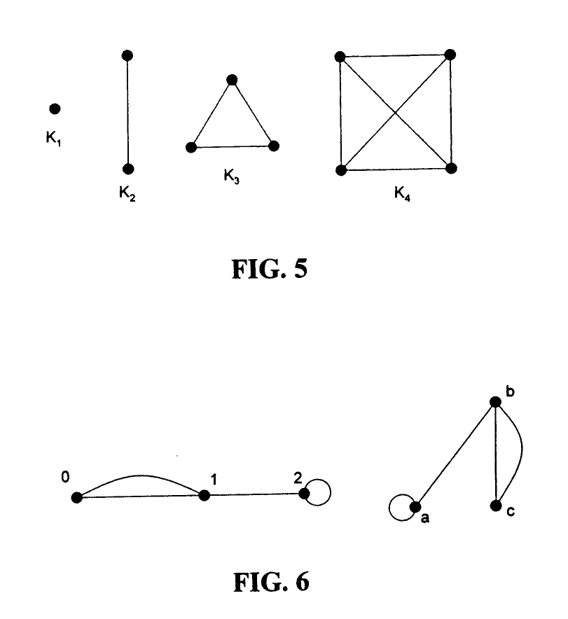

A complete graph Kₐ is a graph consisting of a vertices indexed 0, 1, 2, . . . , a−1, where each vertex is connected with each other vertex of the graph with an edge. FIG. 5 illustrates examples of complete graphs. Two graphs A and B are called isomorphic if there exists a vertex mapping function ƒᵥ and an edge mapping function ƒₑ such that for every edge e of A the function ƒᵥ maps the endpoints of e to the endpoints of ƒₑ(e). Both the edge ƒₑ(e) and it endpoints belong to graph B. FIG. 6 illustrates an example of two isomorphic graphs.

In one embodiment an element of the set G^{(l)} can be indexed in two ways. One way is by using a unique index i which can take all possible values between 0 and |G^{(l)}|−1, where the cardinality |G^{(l)}| is given by Eq. 2. Such an element is represented as Gᵢ^{(l)}. This way of representing graphs is denoted as a ‘global index’. That is, the index used for representing a graph at a particular level is called global index.

Another way to index the element Gᵢ^{(l)} is by using a set of l indexes i₀, i₁, . . . , iₗ₋₁, with l>0. This type of index sequence is denoted as a ‘local index’ sequence. In the trivial case where l=0, the local index sequence consists of one index only, which is equal to zero. The local indexes i₀, i₁, . . . , iₗ₋₁ are related with the global index i of a particular element Gᵢ^{(l)} in a manner illustrated in Eq. 4.

i=(((i₀·n₁)+i₁)·n₂+i₂)·n₃+ . . . +iₗ₋₁ Eq. 4

Eq. 4 can also be written in closed form as:

$$\begin{matrix}i = {i}_{0} \cdot {n}_{1} \cdot {n}_{2} \cdot … \cdot {n}_{l - 1} + {i}_{1} \cdot {n}_{2} \cdot … \cdot \\ {n}_{l - 1} + … + {i}_{l - 2} \cdot {n}_{l - 1} + {i}_{l - 1} \\ = {\sum }_{j = 0}^{l - 1} ( {i}_{j} \cdot {\prod }_{k = j + 1}^{l - 1} {n}_{k} )\end{matrix} \qquad Eq . 5$$

The local indexes i₀, i₁, . . . , iₗ₋₁ satisfy the following inequalities:

0≦i₀≦n₀−1

0≦i₁≦n₁−1 Eq. 6

. . . 0≦iₗ₋₁≦nₗ₋₁−1

In one embodiment the value of a global index i related to a local index sequence i₀, i₁, . . . , iᵢ₋ₗ is between 0 and |G^{(l)}|−1 if inequalities (6) hold and the cardinality |G^{(l)}| is given by (2). This is proved by the following: from Eq. 4 it can be seen that i is a non-decreasing function of i₀, i₁, . . . , iₗ₋₁. Therefore, the smallest value of is produced by setting each local index equal to zero. Therefore, the smallest i is zero. The highest value of i is obtained by setting each local index i₀, i₁, . . . , iₗ₋₁ to be equal to its maximum value. Substituting each local index iⱼ with nⱼ−1 for 0≦j≦l−1 results in:

$$\begin{matrix}{i}_{max} = ( {n}_{0} - 1 ) \cdot {n}_{1} \cdot {n}_{2} \cdot … \cdot {n}_{l - 1} + \\ ( {n}_{1} - 1 ) \cdot {n}_{2} \cdot … \cdot {n}_{l - 1} + … + {n}_{l - 1} - 1 \\ = {n}_{0} \cdot {n}_{1} \cdot {n}_{2} \cdot … \cdot {n}_{l - 1} - {n}_{1} \cdot {n}_{2} \cdot \\ {n}_{3} \cdot … \cdot {n}_{l - 1} + {n}_{1} \cdot {n}_{2} \cdot {n}_{3} \cdot … \cdot {n}_{l - 1} - \\ {n}_{2} \cdot {n}_{3} \cdot {n}_{4} \cdot … \cdot {n}_{l - 1} + {n}_{2} \cdot \\ {n}_{3} \cdot {n}_{4} \cdot … \cdot {n}_{l - 1} - {n}_{3} \cdot {n}_{4} \cdot {n}_{5} \cdot … \cdot \\ {n}_{l - 1} + … - {n}_{l - 1} + {n}_{l - 1} - 1 \\ = {n}_{0} \cdot {n}_{1} \cdot {n}_{2} \cdot … \cdot {n}_{l - 1} - 1 \\ = \vert {G}^{( l )} \vert - 1\end{matrix} \qquad Eq . 7$$

In one embodiment for each global index i between 0 and |G^{(l)}|−1 there exists a unique sequence of local indexes i₀, i₁, . . . , iₗ₋₁ satisfying Eq. 5 and the inequalities in Eq. 6. This is proved by the following: to prove that for a global index i such that 0≦i≦|G^{(l)}|−1 there exists at least one sequence of local indexes i₀, i₁, . . . , iₗ₋₁ satisfying Eq. 5 and Eq. 6, in one embodiment, the following pseudo code represents the construction of such a sequence of local indexes:

LOCAL_INDEXES(i)

| | |
|---|---|
| 1. | for j ← 0 to l-1 |

| | |
|---|---|
| 2. | do if j + 1 ≦ l-1 |

| | |
|---|---|
| 3. | then |

| | |
|---|---|
| 4. | ${i}_{j} ← i div {\prod }_{k = j + 1}^{l - 1} {n}_{k}$ |
| 5. | $i ← i m od {\prod }_{k = j + 1}^{l - 1} {n}_{k}$ |

| | |
|---|---|
| 6. | else |

| | |
|---|---|
| 7. | iⱼ ← i mod nₗ₋₁ |

| | |
|---|---|
| 8. | return {i₀, i₁, . . . , iₗ₋₁} |

It can be seen that the local index sequence i₀, i₁, . . . , iₗ₋₁ produced by the LOCAL_INDEXES satisfies both Eq. 5 and the inequalities in Eq. 6. Therefore, the existence of a local index sequence associated with a global index is proven.

To prove the uniqueness of the local index sequence, it is noted that if two sequences i₀, i₁, . . . , iₗ₋₁ and i₀′, i₁′, . . . , iₗ₋₁′ satisfy Eq. 5 and Eq. 6, then it is not possible for some index q, 0≦q≦l−1, to have i_{q}′≠i_{q}. Assume the opposite, i.e., that there are in indexes q₀, q₁, . . . , qₘ₋₁ such that i_{q}_{₀}′≠i_{q}_{₀}, i_{q}_{₁}′≠i_{q}_{₁}, . . . , i_{q}_{_{m−1}}′≠i_{q}_{_{m−1}}. Also assume that that for all other indexes the sequences i₀, i₁, . . . , iₗ₋₁ and i₀′, i₁′, . . . , iₗ₋₁′ are identical. Since both sequences satisfy Eq. 5 the following identity is true:

(i_{q}_{₀}−i_{q}_{₀}′)·n_{q}_{₀}₊₁· . . . ·nₗ₋₁+(i_{q}_{₁}−i_{q}_{₁}′)·n_{q}_{₁}₊₁· . . . ·nₗ₋₁+ . . . +(i_{q}_{_{m−1}}−i_{q}_{_{m−1}}′)·n_{q}_{_{m−1}}₊₁· . . . ·nₗ₋₁=0 Eq. 8

Without loss of generality, assume that q₀<q₁< . . . <qₘ₋₁. The number (i_{q}_{₀}−i_{q}_{₀}′)·n_{q}_{₀}₊₁· . . . ·nₗ₋₁ is clearly a multiple of n_{q}_{₀₊₁}· . . . ·nₗ₋₁. The addition of the term (i_{q}_{₁}−i_{q}_{₁}′)·n_{q}_{₁}₊₁· . . . ·nₗ₋₁ to this number is not possible to make the sum (i_{q}_{₀}−i_{q}_{₀}′)·n_{q}_{₀}₊₁· . . . ·nₗ₋₁+(i_{q}_{₁}−i_{q}_{₁}′)·n_{q}_{₁}₊₁· . . . ·nₗ₋₁ equal to zero since |i_{q}_{₁}−i_{q}_{₁}′|≦n_{q}_{₁}−1<n_{q}_{₁}≦n_{q}_{₀}₊₁· . . . ·n_{q}_{₁}. The same can be said about the addition of all other terms up to (i_{q}_{_{m−1}}−i_{q}_{_{m−1}}′)·n_{q}_{_{m−1}}₊₁· . . . ·nₗ₋₁. As a result, it is not possible for Eq. 8 to hold. Therefore, the uniqueness of the local index sequence is proven.

The following notation is used to represent a graph associated with global index i and local index sequence i₀, i₁, . . . , iₗ₋₁

Gᵢ^{(l)}=G₍ᵢ_{₀}₎₍ᵢ_{₁}_{) . . . (i}_{_{l−1}}₎^{(l)} Eq. 9

Consider the graph Gᵢ^{(l)} (or G₍ᵢ_{₀}₎₍ᵢ_{₁}_{) . . . (i}_{_{l−1}}₎^{(l)}) of level l. This graph is by definition isomorphic to Kₙ_{ₗ}. This means that this graph consists of nₗ vertices and nₗ·(nₗ−1)/2 edges, where each vertex is connected to every other vertex with an edge. The set Vᵢ^{(l)} (or V₍ᵢ_{₀}₎₍ᵢ_{₁}_{) . . . (i}_{_{l−1}}₎^{(l)}) is defined as the set of all vertices of the graph Gᵢ^{(l)} (or G₍ᵢ_{₀}₎₍ᵢ_{₁}_{) . . . (i}_{_{l−1}}₎^{(l)}). In one embodiment three alternative ways are used to represent the vertices of a graph. One way is using the local index sequence notation. The iₗ-th vertex of a graph G₍ᵢ_{₀}₎₍ᵢ_{₁}_{) . . . (i}_{_{l−1}}₎^{(l)} is represented as v₍ᵢ_{₀}₎₍ᵢ_{₁}_{) . . . (i}_{_{l−1}}₎₍ᵢ_{ₗ}₎^{(l)}, where 0≦iₗ≦nₗ−1. Using the local index sequence notation, the set of all vertices of a graph G₍ᵢ_{₀}₎₍ᵢ_{₁}_{) . . . (i}_{_{l−1}}₎^{(l)} is defined as:

V₍ᵢ_{₀}₎₍ᵢ_{₁}_{) . . . (i}_{_{l−1}}₎^{(l)}={v₍ᵢ_{₀}₎₍ᵢ_{₁}_{) . . . (i}_{_{l−1}}₎^{(l)}:0≦iₗ≦nₗ−1} Eq. 10

A second way to represent the vertices of a graph is using a ‘semi-local’ index sequence notation. In one embodiment a semi-local index sequence consists of a global index of a graph and a local index associated with a vertex. Using the semi-local index sequence notation, the iₗ-th vertex of a graph Gᵢ^{(l)} is represented as v_{i,j}_{ₗ}^{(l)}, where 0≦iₗ≦nₗ−1. In this way, the set of all vertices of a graph Gᵢ^{(l)} is defined as:

Vᵢ^{(l)}={v_{i,j}_{ₗ}^{(l)}: 0≦iₗ≦nₗ−1} Eq. 11

In one embodiment, for each vertex v_{i,j}_{ₗ}^{(l)} a unique global index i_{g}←i·nₗ+iₗ is assigned. It is shown that 0≦i_{g}≦|G^{(l+1)}|−1 and for every semi-local index sequence i, iₗ there exists a unique global index i_{g} such that i_{g}=i·nₗ+iₗ; also for every global index i_{g} there exists a unique semi-local index sequence i, iₗ such that i_{g}=i·nₗ+iₗ.

Substituting i with

$${\sum }_{j = 0}^{l - 1} ( {i}_{j} \cdot {\prod }_{k = j + 1}^{l - 1} {n}_{k} )$$

according to Eq. 5, the global index i_{g} of a vertex is associated with a local index sequence i₀, i₁, . . . , iₗ₋₁, iₗ. The indexes i₀, i₁, . . . , iₗ₋₁ characterize the graph that contains the vertex whereas the index iₗ characterizes the vertex itself. The relationship between i_{g} and i₀, i₁, . . . , iₗ₋₁, iₗ is given in Eq. 12:

$${i}_{g} = {\sum }_{j = 0}^{l} ( {i}_{j} \cdot {\prod }_{k = j + 1}^{l} {n}_{k} ) \qquad Eq . 12$$

In one embodiment a global index i_{g} associated with some vertex of a graph at level l has an one-to-one correspondence to a unique sequence of local indexes i₀, i₁, . . . , iₗ₋₁, iₗ satisfying identity (12), the inequalities (6) and 0≦iₗ≦nₗ−1.

Using the global index notation, the set of all vertices of a graph Gᵢ^{(l)} (or G₍ᵢ_{₀}₎₍ᵢ_{₁}_{) . . . (i}_{_{l−1}}₎^{(l)}) is defined as:

Vᵢ^{(l)}={vᵢ_{_{g}}^{(l)}:i_{g}=i·nₗ+iₗ,0≦iₗ≦nₗ−1} Eq. 13

or

$${V}_{( {i}_{0} ) ( {i}_{1} ) … ( {i}_{l - 1} )}^{( l )} = \{ \begin{matrix}{v}_{{i}_{g}}^{( l )} \text{:} {i}_{g} = {\sum }_{j = 0}^{l} ( {i}_{j} \cdot {\prod }_{k = j + 1}^{l} {n}_{k} ) , \\ 0 \leq {i}_{l} \leq {n}_{l} - 1\end{matrix} \} \qquad Eq . 14$$

The edge which connects two vertices vⱼ^{(l)} and vₖ^{(l)} of a graph at level l is represented as eⱼ₋ₖ^{(l)}. If two vertices v_{i,i}_{ₗ}^{(l)} and v_{i,i}_{ₗ}_{′}^{(l)} are represented using the semi-local index sequence notation, the edge which connects these two vertices is represented as e_{i,i}_{ₗ}_{-i,i}_{ₗ}_{′}^{(l)}. Finally, If two vertices v₍ᵢ_{₀}₎₍ᵢ_{₁}_{) . . . (i}_{_{l−1}}₎₍ᵢ_{ₗ}₎^{(l)} and v₍ᵢ_{₀}₎₍ᵢ_{₁}_{) . . . (i}_{_{l−1}}₎₍ᵢ_{ₗ}_{′)}^{(l)} (are represented using the local index sequence notation, the edge which connects these two vertices is represented as e₍ᵢ_{₀}₎₍ᵢ_{₁}_{) . . . (i}_{_{l−1}}₎₍ᵢ_{ₗ}₎₋₍ᵢ_{₀}₎₍ᵢ_{₁}_{) . . . (i}_{_{l−1}}₎₍ᵢ_{ₗ}_{′)}^{(l)}. The set of all edges of a graph Gᵢ^{(l)} (or G₍ᵢ_{₀}₎₍ᵢ_{₁}_{) . . . (i}_{_{l−1}}₎^{(l)}) is represented as Eᵢ^{(l)} (or E₍ᵢ_{₀}₎₍ᵢ_{₁}_{) . . . (i}_{_{l−1}}₎^{(l)}). This set is formally defined as:

E₍ᵢ_{₀}₎₍ᵢ_{₁}_{) . . . (i}_{_{l−1}}₎^{(l)}={e₍ᵢ_{₀}₎₍ᵢ_{₁}_{) . . . (i}_{_{l−1}}₎₍ᵢ_{ₗ}₎₋₍ᵢ_{₀}₎₍ᵢ_{₁}_{) . . . (i}_{_{l−1}}₎₍ᵢ_{ₗ}_{′)}^{(l)}:0≦iₗ≦nₗ−1,0≦iₗ′≦nₗ−1,iₗ≠iₗ′} Eq. 15

or

Eᵢ^{(l)}={e_{i,i}_{ₗ}_{-i,i}_{ₗ}_{′}^{(l)}:0≦iₗ≦nₗ−1,0≦iₗ′≦nₗ−1,iₗ≠iₗ′} Eq. 16

or

Eᵢ^{(l)}{eᵢ_{_{g}}₋ᵢ_{_{g}}_{′}^{(l)}:i_{g}=i·nₗ+iₗ,i_{g}′=i·nₗ+iₗ′,0≦iₗ≦nₗ−1;0≦iₗ′≦nₗ−1,iₗ≠iₗ′} Eq. 17

In one embodiment, the notation used for edges between vertices of different graphs of the same level is the same as the notation used for edges between vertices of the same graph. For example, an edge connecting two vertices v₍ᵢ_{₀}₎₍ᵢ_{₁}_{) . . . (i}_{_{l−1}}₎₍ᵢ_{ₗ}₎^{(l)} and v₍ᵢ_{₀}_{′)(i}_{₁}_{′) . . . (i}_{_{l−1}}_{′)(i}_{ₗ}_{′)}^{(l)}, which are represented using the local index sequence notation is denoted as e₍ᵢ_{₀}₎₍ᵢ_{₁}_{) . . . (i}_{_{l−1}}₎₍ᵢ_{ₗ}₎₋₍ᵢ_{₀}_{′)(i}_{₁}_{′) . . . (i}_{_{l−1}}_{′)(i}_{ₗ}_{′)}^{(l)}.

In one embodiment alternative notations for the sets of vertices and edges of a graph G are V(G) and E(G) respectively. In addition, the term ‘simple’ from graph theory is used to refer to graphs, vertices and edges associated with the last level L−1. The graphs, vertices and edges of all other levels l, l<L−1 are referred to as ‘generalized’. The level associated with a particular graph G, vertex v or edge e is denoted as l(G), l(v) or l(e) respectively.

A vertex to graph mapping function ƒ^{v→g} is defined as a function that accepts as input a vertex of a graph at a particular level l, l<L−1 and returns a graph at a next level l+1 that is associated with the same global index or local index sequence as the input vertex.

ƒ^{v→g}(v_{i,i}_{ₗ}^{(l)})=Gₙ_{ₗ}_{·i+i}ₗ^{(l+1)} Eq. 18

Alternative definitions of the function ƒ^{v→g} are:

ƒ^{v→g}(vᵢ^{(l)})=Gᵢ^{(l+1)} Eq. 19

and

ƒ^{v→g}(v₍ᵢ_{₀}₎₍ᵢ_{₁}_{) . . . (i}_{_{l−1}}₎₍ᵢ_{ₗ}₎^{(l)})=G₍ᵢ_{₀}₎₍ᵢ_{₁}_{) . . . (i}_{_{l−1}}₎₍ᵢ_{ₗ}₎^{(l+1)} Eq. 20

Similarly, a graph to vertex mapping function ƒ^{g→v} is defined as a function that accepts as input a graph at a particular level l, l>0 and returns a vertex at a previous level l−1 that is associated with the same global index or local index sequence as the input graph.

ƒ^{g→v}(Gᵢ^{(l)})=v_{└i/n}_{_{l−1}}_{┘,i mod n}_{_{l−1}}^{(l-1)} Eq. 21

Alternative definitions of the function ƒ^{g→v} are:

ƒ^{g→v}(Gᵢ^{(l)})=vᵢ^{(l-1)} Eq. 22

and

ƒ^{g→v}(G₍ᵢ_{₀}₎₍ᵢ_{₁}_{) . . . (i}_{_{l−1}}₎^{(l)})=v₍ᵢ_{₀}₎₍ᵢ_{₁}_{) . . . (i}_{_{l−1}}₎^{(l-1)} Eq. 23

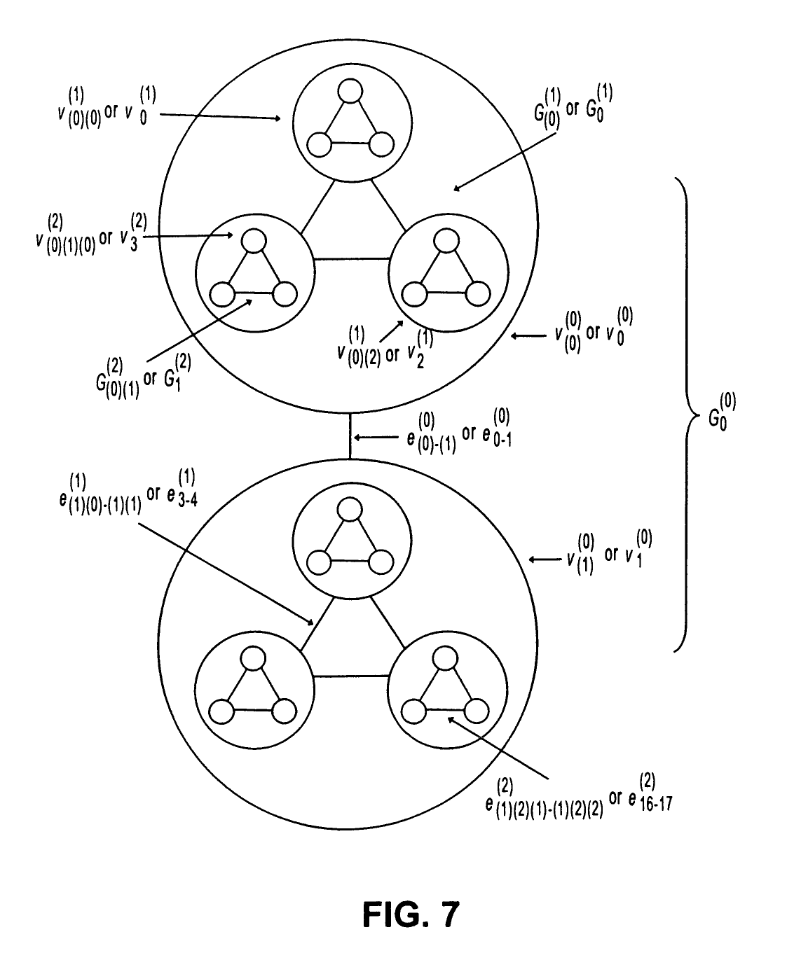

The significance of the vertex to graph and graph to vertex mapping functions lies on the fact that they allow us to represent pictorially all graphs of all levels defined for a particular operand input size. First, each vertex of a graph is represented as a circle. Second, inside each circle, a graph is drawn at the next level, which maps to the vertex represented by the circle. As an example, FIG. 7 illustrates how the graphs are drawn defined for an 18 by 18 multiplication.

In the example illustrated in FIG. 7, N=18. N can be written as the product of three factors, i.e., 2, 3 and 3. Setting the number of levels L to be equal to 3 and n₀=2, n₁=n₂=3, the graphs are drawn of all levels associated with the multiplication as shown in FIG. 7. It can be seen that the vertices of the graphs at the last level do not contain any other graphs. This is the reason they are called ‘simple’. It can also be seen that each vertex at a particular level contains as many sets of graphs as the number of levels below. This is the reason why sets of graphs are referred to as ‘levels’.

In one embodiment the term ‘spanning’ is overloaded from graph theory. The term spanning is used to refer to edges or collections of edges that connect vertices of different graphs at a particular level.

A spanning plane is defined as a graph resulting from the join ‘+’ operation between two sub-graphs of two different graphs of the same level. Each of the two sub-graphs consists of a single edge connecting two vertices. Such two sub-graphs are described below:

{{v₍ᵢ_{₀}₎₍ᵢ_{₁}_{) . . . (i}_{_{l−1}}₎₍ᵢ_{ₗ}₎^{(l)},v₍ᵢ_{₀}₎₍ᵢ_{₁}_{) . . . (i}_{_{l−1}}_{)(î}_{ₗ}₎^{(l)}},e₍ᵢ_{₀}₎₍ᵢ_{₁}_{) . . . (i}_{_{l−1}}₎₍ᵢ_{ₗ}₎₋₍ᵢ_{₀}₎₍ᵢ_{₁}_{) . . . (i}_{_{l−1}}_{)(î}_{ₗ}₎^{(l)}}, and

{{v₍ᵢ_{₀}_{′)(i}_{₁}_{′) . . . (i}_{_{l−1}}_{′)(i}_{ₗ}_{′)}^{(l)},v₍ᵢ_{₀}_{′)(i}_{₁}_{′) . . . (i}_{_{l−1}}_{′)(î}_{ₗ}_{′)}^{(l)}},e₍ᵢ_{₀}_{′)(i}_{₁}_{′) . . . (i}_{_{l−1}}_{′)(i}_{ₗ}_{′)-(i}_{₀}_{′)(i}_{₁}_{′) . . . (i}_{_{l−1}}_{′)(î}_{ₗ}_{′)}^{(l)}} Eq. 24

In addition, the local index sequences characterizing the two edges which are joined for producing a spanning plane need to satisfy the following conditions:

i₀=i₀′,i₁=i₁′, . . . ,i_{q}≠i_{q}′, . . . ,iₗ=iₗ′,îₗ=îₗ′ Eq. 25

Eq. 25 can be also written in closed form as follows:

(∃q,qε[0,l−1]:i_{q}≠i_{q}′) [symbol] (∀jε[0,l],j≠q:iⱼ=iⱼ′) [symbol] (îₗ=îₗ′) Eq. 26

Eq. 25 or Eq. 26 indicate that all corresponding local indexes of the joined edges in a spanning plane are identical apart from the indexes in a position q, where 0≦q≦l−1. Since i_{q}≠i_{q}′, this means that the two edges that are joined to form a spanning plane are associated with different graphs. In the special case where q=l−1, the two graphs containing the joined edges of a spanning plane map to vertices of the same graph at level l−1, since i₀=i₀′, i₁=i₁′, . . . , iₗ₋₂=iₗ₋₂′.

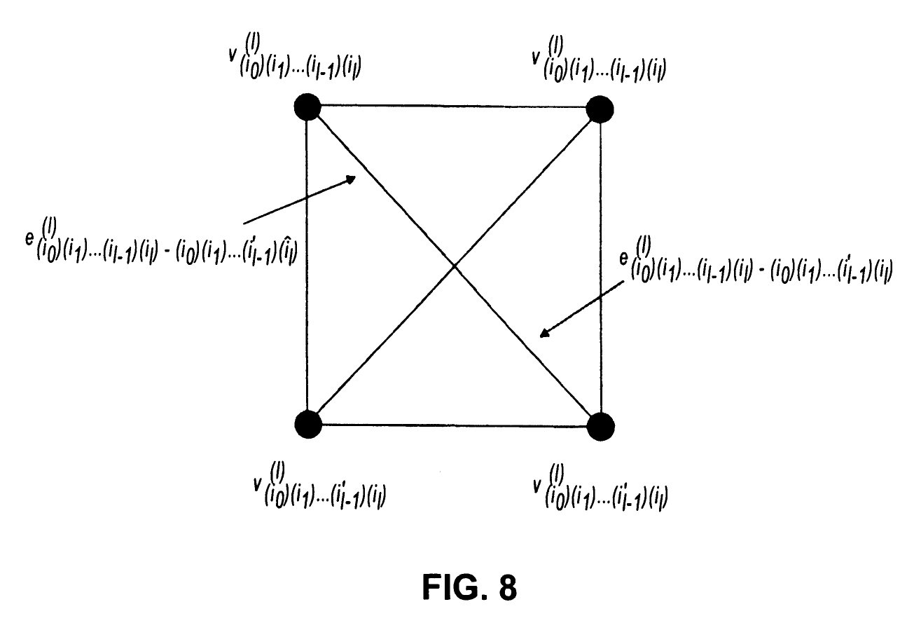

The join operation ‘+’ between two graphs is defined as a new graph consisting of the two operands of ‘+’ plus new edges connecting every vertex of the first operand to every vertex of the second operand. A spanning plane produced by joining the two sub-graphs of Eq. 24 with Eq. 26 holding and q=l−1 is illustrated in FIG. 8. As illustrated in FIG. 8, vertices and edges are represented using the local index sequence notation.

Using the local index sequence notation, a spanning plane can be formally defined as:

$${s}_{( {i}_{0} ) ( {i}_{1} ) … ( {i}_{q} - {i}_{q}^{′} ) … ( {i}_{l - 1} ) ( {i}_{l} - {\overline{i}}_{l} ) =} \{ \{ {v}_{( {i}_{0} ) … ( {i}_{q} ) … ( {i}_{l - 1} ) ( {i}_{l} )}^{( l )} , {v}_{( {i}_{0} ) … ( {i}_{q} ) … ( {i}_{l - 1} ) ( {\overline{i}}_{l} )}^{( l )} \} , {e}_{( {i}_{0} ) … ( {i}_{q} ) … ( {i}_{l - 1} ) ( {i}_{l} ) - ( {i}_{0} ) … ( {i}_{q} ) … ( {i}_{l - 1} ) ( {\overline{i}}_{l} )}^{( l )} \} + \{ \{ {v}_{( {i}_{0} ) … ( {i}_{q}^{′} ) … ( {i}_{l - 1} ) ( {i}_{l} )}^{( l )} , {v}_{( {i}_{0} ) … ( {i}_{q}^{′} ) … ( {i}_{l - 1} ) ( {\overline{i}}_{l} )}^{( l )} \} , {e}_{( {i}_{0} ) … ( {i}_{q}^{′} ) … ( {i}_{l - 1} ) ( {i}_{l}^{′} ) - ( {i}_{0} ) … ( {i}_{q}^{′} ) … ( {i}_{l - 1} ) ( {\overline{i}}_{l} )}^{( l )} \} \qquad Eq . 27$$

Since the local index sequence notation is lengthy, the shorter ‘semi-local’ index sequence notation is used for representing a spanning plane:

s_{i,i}_{ₗ}_{-i,î}_{ₗ}_{-i′,i}_{ₗ}_{-i′,î}_{ₗ}^{p(l)}={{v_{i,i}_{ₗ}^{(l)},v_{i,î}_{ₗ}^{(l)}},e_{i,i}_{ₗ}_{-i,î}_{ₗ}^{(l)}}+{{v_{i′,i}_{ₗ}^{(l)},v_{i′,î}_{ₗ}^{(l)}},e_{i′,i}_{ₗ}_{-i′,î}_{ₗ}^{(l)}} Eq. 28

In the definition of Eq. 28 above, the value of the index i is given by identity Eq. 5 and:

i′=i₀·n₁·n₂· . . . ·nₗ₋₁+i₁·n₂· . . . ·nₗ₋₁+ . . . +i_{q}′·n_{q+1}· . . . nₗ₋₁+ . . . +iₗ₋₂·nₗ₋₁+iₗ₋₁ Eq. 29

In one embodiment global index notation is used for representing a spanning plane. Using the global index notation, a spanning plane is defined as:

sᵢ_{_{g}}_{-î}_{_{g}}₋ᵢ_{_{g}}_{′-î}_{_{g}}_{′}^{p(l)}={{vᵢ_{_{g}}^{(l)},v_{î}_{_{g}}^{(l)}},eᵢ_{_{g}}_{-î}_{_{g}}^{(l)}}+{{vᵢ_{_{g}}_{′}^{(l)},v_{î}_{_{g}}_{′}^{(l)}},eᵢ_{_{g}}_{′-î}_{_{g}}_{′}^{(l)}} Eq. 30

In the Eq. 30 notation above:

i_{g}=i·nₗ+iₗ,î_{g}=i·nₗ+îₗ,i_{g}′=i′·nₗ+iₗ,î_{g}′=i′·nₗ+îₗ Eq. 31

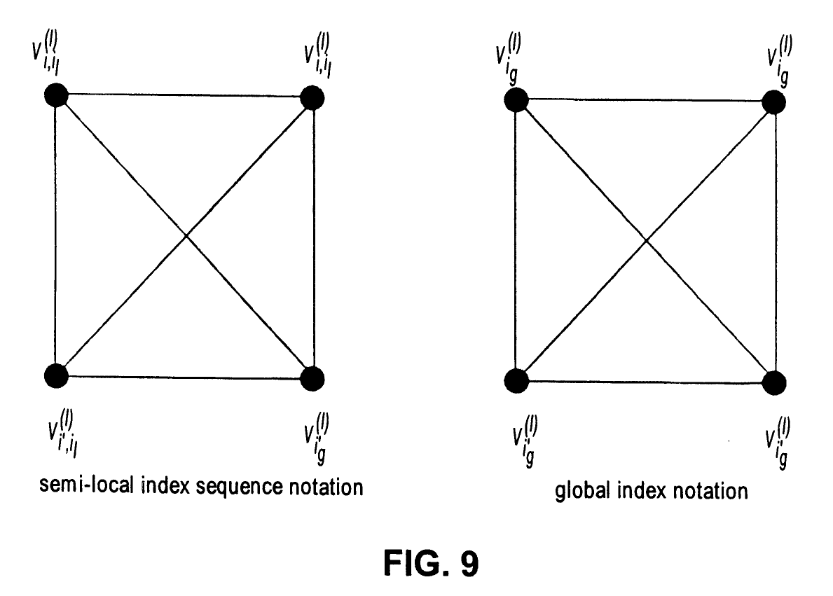

The index i in identity (31) is given by identity (5) whereas the index i′ in (31) is given by identity (29). A pictorial representation of spanning planes using the semi-local index sequence and global index notations is given if FIG. 9.

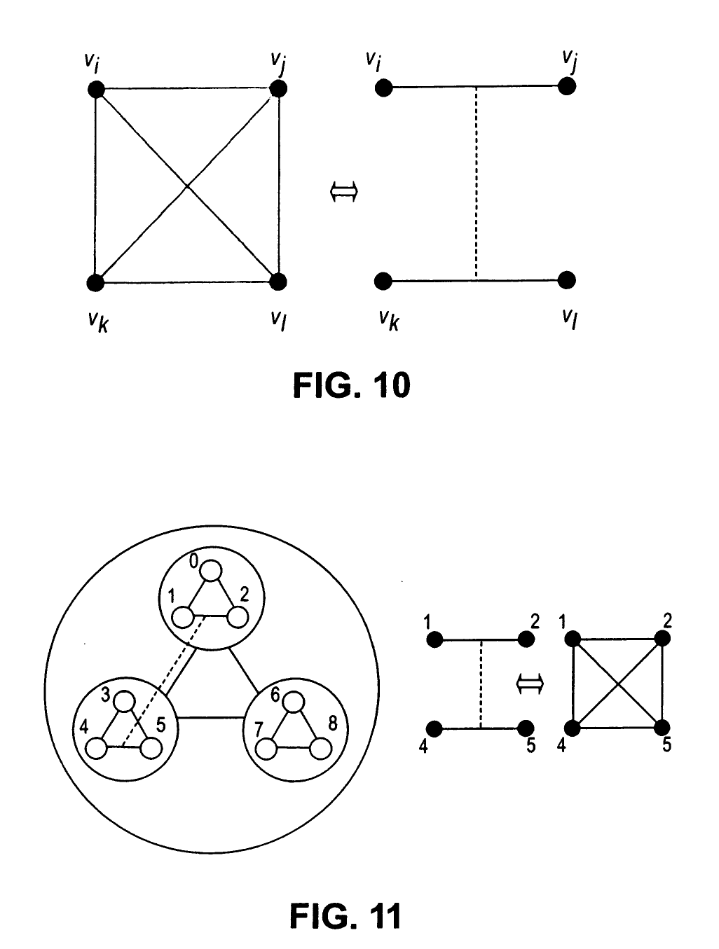

In another embodiment, an alternative pictorial representation of a spanning plane used as illustrated in FIG. 10. The vertices shown in FIG. 10 are represented using the global index notation. The level of the vertices is omitted for simplicity.

An example of a spanning plane is illustrated in FIG. 11. The example shows the graphs built for a 9-by-9 multiplication and the global indexes of all simple vertices. The example also shows the spanning plane defined by the edges e₁₋₂^{(l)} and e₄₋₅^{(l)}.

A spanning edge is an edge that connects two vertices v₍ᵢ_{₀}₎₍ᵢ_{₁}_{) . . . (i}_{_{l−1}}₎₍ᵢ_{ₗ}₎^{(l)} and v₍ᵢ_{₀}_{′)(i}_{₁}_{′) . . . (i}_{_{l−1}}_{′)(i}_{ₗ}_{′)}^{(l)} of different graphs of the same level. The local index sequences i₀, i₁, . . . , iₗ and i₀′, i₁′, . . . , iₗ′ which describe the two vertices need to satisfy the following conditions:

i₀=i₀′,i₁=i₁′, . . . ,i_{q}≠i_{q}′, . . . ,iₗ=iₗ′ Eq. 32

or (in closed form):

(∃q,qε[0,l−1]:i_{q}≠i_{q}′)̂(∀jε[0,l],j≠q:iⱼ=iⱼ′) Eq. 33

From the conditions in Eq. 33 it is evident that a spanning edge connects vertices with the same last local index (iₗ=iₗ′). Second, the vertices which are endpoints of a spanning edge are associated with different graphs of G^{(l)} since i_{q}≠i_{q}′. Third, in the special case where q=l−1, the two graphs containing the endpoints of a spanning edge map to vertices of the same graph at level l−1, since i₀=i₀′, i₁=i₁′, . . . , iₗ₋₂=iₗ₋₂′.

A spanning edge can be represented formally using the local index sequence notation as follows:

s₍ᵢ_{₀}₎₍ᵢ_{₁}_{) . . . (i}_{_{q}}₋ᵢ_{_{q}}_{′) . . . (i}_{ₗ}₎^{e(l)}={v₍ᵢ_{₀}₎₍ᵢ_{₁}_{) . . . (i}_{_{q}}_{′) . . . (i}_{ₗ}₎^{(l)}}+{v₍ᵢ_{₀}₎₍ᵢ_{₁}_{) . . . (i}_{_{q}}_{′) . . . (i}_{ₗ}₎^{(l)}}={{v₍ᵢ_{₀}₎₍ᵢ_{₁}_{) . . . (i}_{_{q}}_{′) . . . (i}_{ₗ}₎^{(l)},v₍ᵢ_{₀}₎₍ᵢ_{₁}_{) . . . (i}_{_{q}}_{′) . . . (i}_{ₗ}₎^{(l)}},e₍ᵢ_{₀}₎₍ᵢ_{₁}_{) . . . (i}_{_{q}}_{) . . . (i}_{ₗ}₎₋₍ᵢ_{₀}₎₍ᵢ_{₁}_{) . . . (i}_{_{q}}_{′) . . . (i}_{ₗ}₎^{(l)}} Eq. 34

A spanning edge can be also represented formally using the semi-local index sequence notation:

s_{i,i}_{ₗ}_{-i′,i}_{ₗ}^{e(l)}={v_{i,i}_{ₗ}^{(l)}}+{v_{i′,i}_{ₗ}^{(l)}}={{v_{i,i}_{ₗ}^{(l)},v_{i′,i}_{ₗ}^{(l)}},e_{i,i}_{ₗ}_{-i′,i}^{(l)}} Eq. 35

In the definition in Eq. 35, the value of the index i is given by identity shown in Eq. 5 and:

i′=i₀·n₁·n₂· . . . ·nₗ₋₁+i₁·n₂· . . . ·nₗ₋₁+ . . . +i_{q}′·n_{q+1}+ . . . +iₗ₋₂·nₗ₋₁+iₗ₋₁ Eq. 36

In another embodiment a third way to represent a spanning edge is by using the global index notation:

sᵢ_{_{g}}₋ᵢ_{_{g}}_{′}^{e(l)}={vᵢ_{_{g}}^{(l)}}+{vᵢ_{_{g}}_{′}^{(l)}}={{vᵢ_{_{g}}^{(l)},vᵢ_{_{g}}_{′}^{(l)}},eᵢ_{_{g}}₋ᵢ_{_{g}}_{′}^{(l)}} Eq. 37

To further aid in understanding, a set of mappings defined between edges, spanning edges and spanning planes are introduced. In what follows the term ‘corresponding’ is used to refer to vertices of different graphs of the same level that are associated with the same last local index. Two edges of different graphs of the same level are called ‘corresponding’ if they are connecting corresponding endpoints.

A generalized edge (i.e., an edge of a graph Gᵢ^{(l)}, 0≦l≦L−1) or a spanning edge can map to a set of spanning edges and spanning planes through a mapping function ƒ^{e→s}. The function ƒ^{e→s} accepts as input an edge (if it is a spanning edge, the endpoints are excluded) and returns the set of all possible spanning edges and spanning planes that can be considered between the corresponding vertices and edges of the graphs that map to the endpoints of the input edge through the function ƒ^{v→g}.

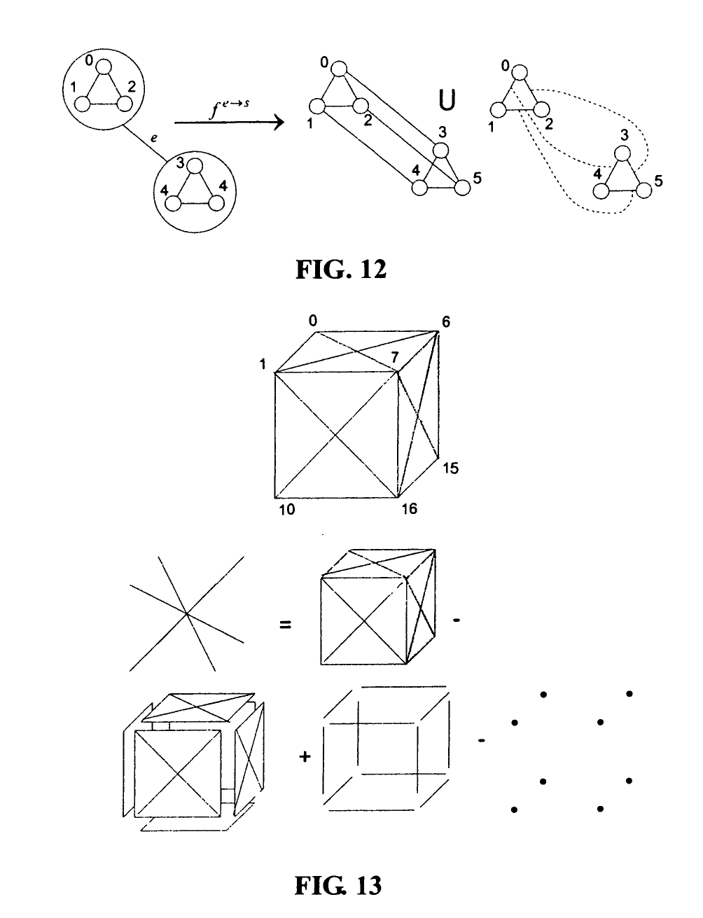

Before the ƒ^{e→s} mapping is described formally an example is introduced. In the example illustrated in FIG. 12, the generalized edge e (its level and indexes are omitted for simplicity) connects two vertices that map to the triangles 0-1-2 and 3-4-5. This mapping is done through the function ƒ^{v→g}. Edge e maps to three spanning edges and three spanning planes as shown in FIG. 12 through the function ƒ^{e→s}. The spanning edges are those connecting the vertices with global indexes 0 and 3, 1 and 4, and 2 and 5 respectively. The spanning planes are those which are produced by the join operation between edges 0-1 and 3-4, 0-2 and 3-5, and 1-2 and 4-5 respectively.

Using the local index sequence location the function ƒ^{e→s} can be formally defined as:

ƒ^{e→s}(e₍ᵢ_{₀}_{) . . . (i}_{_{q}}_{) . . . (i}_{_{l−1}}₎₍ᵢ_{ₗ}₎₋₍ᵢ_{₀}_{) . . . (i}_{_{q}}_{′) . . . (i}_{_{l−1}}₎₍ᵢ_{ₗ}₎^{(l)})={s₍ᵢ_{₀}_{) . . . (i}_{_{q}}₋ᵢ_{_{q}}_{′) . . . (i}_{_{l−1}}₎₍ᵢ_{ₗ}₎₍ⱼ₎^{e(l+1)}:0≦j≦nₗ₊₁−1}∪{s₍ᵢ_{₀}_{) . . . (i}_{_{q}}₋ᵢ_{_{q}}_{′) . . . (i}_{_{l−1}}₎₍ᵢ_{ₗ}₎₍ⱼ₋ₖ₎:0≦j≦nₗ₊₁−1,0≦k≦nₗ₊₁−1,j≠k} Eq. 38

In the definition in Eq. 38 the index position q takes all possible values from the set [0, l].

The mapping ƒ^{e→s}^{^{e}} is defined between edges and spanning edges only and the mapping ƒ^{e→s}^{^{p}} is defined between edges and spanning planes only.

ƒ^{e→s}^{^{e}}(e₍ᵢ_{₀}_{) . . . (i}_{_{q}}_{) . . . (i}_{_{l−1}}₎₍ᵢ_{ₗ}₎₋₍ᵢ_{₀}_{) . . . (i}_{_{q}}_{′) . . . (i}_{_{l−1}}₎₍ᵢ_{ₗ}₎^{(l)})={s₍ᵢ_{₀}_{) . . . (i}_{_{q}}₋ᵢ_{_{q}}_{′) . . . (i}_{_{l−1}}₎₍ᵢ_{ₗ}₎₍ⱼ₎^{e(l+1)}:0≦j≦nₗ₊₁−1} Eq. 39

and

ƒ^{e→s}^{^{p}}(e₍ᵢ_{₀}_{) . . . (i}_{_{q}}_{) . . . (i}_{_{l−1}}₎₍ᵢ_{ₗ}₎₋₍ᵢ_{₀}_{) . . . (i}_{_{q}}_{′) . . . (i}_{_{l−1}}₎₍ᵢ_{ₗ}₎^{(l)})={s₍ᵢ_{₀}_{) . . . (i}_{_{q}}₋ᵢ_{_{q}}_{′) . . . (i}_{_{l−1}}₎₍ᵢ_{ₗ}₎₍ⱼ₋ₖ₎^{p(l+1)}:0≦j≦nₗ₊₁−1,0≦k≦nₗ₊₁−1,j≠k}) Eq. 40

The definitions in Eq. 39 and Eq. 40 the index position q takes all possible values from the set [0, l].

In one embodiment mappings between sets of vertices and products are defined. The inputs to a multiplication process of an embodiment are the polynomials a(x) b(x) of degree N−1:

a(x)=a_{N-1}·x^{N-1}+a_{N-2}·x^{N-2}+ . . . +a₁·x+a₀,

b(x)=b_{N-1}·x^{N-1}+b_{N-2}·x^{N-2}+ . . . +b₁·x+b₀ Eq. 41

The set V of m vertices are defined as:

V={vᵢ_{₀},vᵢ_{₁}, . . . ,vᵢ_{_{m−1}}} Eq. 42

The elements of V are described using the global index notation and their level is omitted for the sake of simplicity. Three mappings P(P), P₁(P) and P₂(V) are defined between the set V and products as follows:

P(V)=(aᵢ_{₀}+aᵢ_{₁}+ . . . +aᵢ_{_{m−1}})·(bᵢ_{₀}+bᵢ_{₁}+ . . . +bᵢ_{_{m−1}}) Eq. 43

P₁(V)={aᵢ_{_{q}}·bᵢ_{_{q}}:0≦q≦m−1} Eq. 44

P₂(V)={(aᵢ+aⱼ)·(bᵢ+bⱼ):i,jε{i₀,i₁, . . . ,iₘ₋₁},i≠j} Eq. 45

The product generation process accepts as input two polynomials of degree N−1 as shown in Eq. 41. The degree N of the polynomials can be factorized as shown in Eq. 1. The product generation process of an embodiment is the first stage of a two step process which generates a Karatsuba-like multiplication routine that computes c(x)=a(x) b(x). Since the polynomials a(x) and b(x) are of degree N−1, the polynomial c(x) must be of degree 2N−2. The polynomial c(x) is represented as:

c(x)=c_{2N-2}·x^{2N-2}+c_{2N-3}·x^{2N-3}+ . . . +c₁·x+c₀ Eq. 46

Where

$${c}_{i} = \{ \begin{matrix}{\sum }_{j = 0}^{i} {a}_{j} \cdot {b}_{i - j} , if i ∈ [ 0 , N - 1 ] \\ {\sum }_{j = i - N + 1}^{N - 1} {a}_{j} \cdot {b}_{i - j} if i ∈ [ N , 2 N - 2 ]\end{matrix} \qquad Eq . 47$$

The expression in Eq. 47 can be also written as:

c₀=a₀·b₀

c₁=a₀·b₁+a₁·b₀

. . .

c_{N-1}=a_{N-1}·b₀+a_{N-2}·b₁+ . . . +a₀·b_{N-1}

c_{N}=a_{N-1}·b₁+a_{N-2}·b₂+ . . . +a₁·b_{N-1}

. . .

c_{2N-2}=a_{N-1}·b_{N-1} Eq. 48

Our framework produces a multiplication process that computes all coefficients c₀, c₁, . . . , c_{2N-2}. At the preprocessing stage, the product generation process generates all graphs Gᵢ^{(l)} for every level l, 0≦l≦L−1. The generation of products is realized by executing a product creation process of an embodiment, shown in pseudo code as CREATE_PRODUCTS:

CREATE_PRODUCTS( )
1. P^{a} ← Ø
2. for i ← 0 to |G^{(L-1)}|−1
3. do P^{a} ← P^{a} ∪ P₁(V(Gᵢ^{(L-1)}))
4 P^{a} ← P^{a} ∪ P₂(V(Gᵢ^{(L-1)}))
5. GENERALIZED_EDGE_PROCESS( )
6. return P^{a}

The process GENERALIZED_EDGE_PROCESS of an embodiment is described below in pseudo code.

GENERALIZED_EDGE_PROCESS( )
1. for l ← 0 to L−2
2. do for i ← to |G^{(l)}|−1
3. do for j ← 0 to n₁−1
4. do for k ← 0 to n₁−1
5. do if j = k
6. then
7. continue
8. else
9. S₁ ← f^{e→s}^{^{e}} (e_{i,j-i,k}^{(l)})
10. S₂ ← f^{e→s}^{^{p}} (e_{i,j-i,k}^{(l)})
11. if l+1 = L−1
12. then
13. for every s ∈ S₁ ∪ S₂
14. do P^{a} ← P^{a} ∪ P(V(s))
15. else
16. for every s ∈ S₁
17. do SPANNING_EDGE_PROCESS(s)
18. for every s ∈ S₂
19. do SPANNING_PLANE_PROCESS(s)
20. return

A shown above, the process GENERALIZED_EDGE_PROCESS( ) processes each generalized edge from the set G^{(l)} one-by-one. If the level of a generalized edge is less than L−2, then the procedure GENERALIZED_EDGE_PROCESS( ) invokes two other processes for processing the spanning edges and spanning planes associated with the generalized edge. The first of the two, SPANNING_EDGE_PROCESS( ), is shown below in pseudo code:

| SPANNING_EDGE_PROCESS(s) | |
|---|---|
| 1. | l ← l(s) |
| 2. | S₁ ← f^{e→s}^{^{e}} (s) |
| 3. | S₂ ← f^{e→s}^{^{p}} (s) |
| 4. | if l+1 = L−1 |
| 5. | then |
| 6. | for every s′ ∈ S₁ ∪ S₂ |
| 7. | do P^{a} ← P^{a} ∪ P(V(s′)) |
| 8. | else |
| 9. | for every s′ ∈ S₁ |
| 10. | do SPANNING_EDGE_PROCESS(s′ ) |
| 11. | for every s′ ∈ S₂ |
| 12. | do SPANNING_PLANE_PROCESS(s′ ) |
| 13. | return |

The second process, SPANNING_PLANE_PROCESS( ), is shown below in pseudo code:

| SPANNING_PLANE_PROCESS(s) | |
|---|---|
| 1. | l ← l(s) |
| 2. | if l= L−1 |
| 3. | then |
| 4. | P^{a} ← P^{a} ∪ P(V(s)) |
| 5. | else |
| 6. | V̅ ← { V(s) } |
| 7. | while l < L−1 |
| 8. | do V̅ ← EXPAND_VERTEX_SETS( V̅ ) |
| 9. | l ← l+1 |
| 10. | for every v′ ∈ V̅ |
| 11. | do P^{a} ← P^{a} ∪ P(v′) |
| 12. | return |

In one embodiment the process EXPAND_VERTEX_SETS( ) is shown below in pseudo code. The notation g(v) is used to refer to the global index of a vertex v.

| EXPAND_VERTEX_SETS( V̅ ) | |
|---|---|
| 1. | Vᵣ ← Ø |
| 2. | for every V′ ∈ V̅ |
| 3. | do Vᵣ ← Vᵣ ∪ EXPAND_SINGLE_VERTEX_SET(V′ ) |
| 4. | return Vᵣ |
| EXPAND_SINGLE_VERTEX_SET(V ) | |
| 1. | Vᵣ ← Ø |
| 2. | let v ∈ V |
| 3. | l ← l(v) |
| 4. | for p ← 0 to nₗ₊₁ −1 |
| 5. | do for q ← 0 to nₗ₊₁ −1 |
| 6. | do if p = q |
| 7. | then |
| 8. | continue |
| 9. | else |
| 10. | U_{pq} ← Ø |
| 11. | for i ← 0 to \|V \| −1 |
| 12. | do let vᵢ ← the i-th element of V |
| 13. | gᵢ ← g(vᵢ) |
| 14. | U_{pq} ← U_{pq} ∪ {v_{gi,p}^{(l+1)}} ∪ {v_{gi,q}^{(l+1)}} |
| 15. | Vᵣ ← Vᵣ ∪U_{pq} |
| 16. | for q ← 0 to nₗ₊₁ −1 |
| 17. | do U_{q} ← Ø |
| 18. | for i ← 0 to \|V \| −1 |
| 19. | do let vᵢ ← the i-th element of V |
| 20. | gᵢ ← g(vᵢ) |
| 21. | U_{q} ← U_{q} ∪ {v_{gi,q}^{(l+1)}} |
| 22. | Vᵣ ← Vᵣ ∪U_{q} |
| 23. | return Vᵣ |

In one embodiment for all simple graphs, the products associated with simple vertices and simple edges are determined and these products are added to the set P^{a}. This occurs in lines 3 and 4 of the process CREATE_PRODUCTS( ). Second, for all generalized edges at each level, one embodiment does the following: first, each generalized edge is decomposed into its associated spanning edges and spanning planes. This occurs in lines 9 and 10 of the process GENERALIZED_EDGE_PROCESS( ).

To find products associated with each spanning edge, it is determined if a spanning edge connects simple vertices. If it does, the process computes the product associated with the spanning edge from the global indexes of the endpoints of the edge. This occurs in line 14 of the process GENERALIZED_EDGE_PROCESS( ). If a spanning edge does not connect simple vertices, this spanning edge is further decomposed into its associated spanning edges and spanning planes. This occurs in lines 2 and 3 of the process SPANNING_EDGE_PROCESS( ). For each resulting spanning edge that is not at the last level the process SPANNING_EDGE_PROCESS( ) is performed recursively. This occurs in line 10 of the process SPANNING_EDGE_PROCESS( ).

To find products associated with each spanning plane, it is determined if the vertices of a spanning plane are simple or not. If they are simple, the product associated with the global indexes of the plane's vertices is formed and it is added to the set pa (line 14 of the process GENERALIZED_EDGE_PROCESS( )). If the vertices of a plane are not simple, then the process expands these generalized vertices into graphs and creates sets of corresponding vertices and edge endpoints. This occurs in lines 14 and 21 of the process EXPAND_SINGLE_VERTEX_SET( ). For each such set the expansion is performed down to the last level. This occurs in lines 7-9 of the process SPANNING_PLANE_PROCESS( ).

There are four types of products created. The first type includes all products created from simple vertices. The set of such products P₁^{a} is:

P₁^{a}={P({v₍ᵢ_{₀}₎₍ᵢ_{₁}_{) . . . (i}_{_{L−2}}₎₍ᵢ_{_{L−1}}₎^{(L-1)}}):iⱼε[o,nⱼ−1]∀jε[0,L−1]} Eq. 49

A second type of products includes those products formed by the endpoints of simple edges. The set of such products P₂^{a} is:

P₂^{a}={P({v₍ᵢ_{₀}₎₍ᵢ_{₁}_{) . . . (i}_{_{L−2}}₎₍ᵢ_{_{L−1}}₎^{(L-1)},v₍ᵢ_{₀}₎₍ᵢ_{₁}_{) . . . (i}_{_{L−2}}₎₍ᵢ_{_{L−1}}₎^{(L-1)}}):iⱼε[o,nⱼ−1]∀jε[0,L−1],îₗε[0,n_{L-1}−1],iₗ≠îₗ} Eq. 50

A third type of products includes all products formed by endpoints of spanning edges. These spanning edges result from recursive spanning edge decomposition down to the last level L−1. The set of such products P₃^{a} has the following form:

P₃^{a}{P({v₍ᵢ_{₀}₎₍ᵢ_{₁}_{) . . . (i}_{_{q}}_{) . . . (i}_{_{L−1}}₎^{(L-1)},v₍ᵢ_{₀}₎₍ᵢ_{₁}_{) . . . (i}_{_{q}}_{′)(i}_{_{L−1}}₎^{(L-1)}}):iⱼε[o,nⱼ−1]∀jε[0,L−1],i_{q}′ε[0,n_{q}−1],qε[0,L−2],i_{q}≠i_{q}′} Eq. 51

A fourth type of products includes those products formed from spanning planes after successive vertex set expansions have taken place. One can show by induction that this set of products P₄^{a} has the following form:

P₄^{a}={P({v₍ᵢ_{₀}_{) . . . (i}_{_{q0}}_{) . . . (i}_{_{q1}}_{) . . . (i}_{_{qm−1}}_{) . . . (i}_{_{L−1}}₎^{(L-1)},v₍ᵢ_{₀}_{) . . . (i}_{_{q0}}_{′) . . . (i}_{_{q1}}_{) . . . (i}_{_{qm−1}}_{) . . . (i}_{_{L−1}}₎^{(L-1)},v₍ᵢ_{₀}_{) . . . (i}_{_{q0}}_{) . . . (i}_{_{q1}}_{′) . . . (i}_{_{qm−1}}_{) . . . (i}_{_{L−1}}₎^{(L-1)},v₍ᵢ_{₀}_{) . . . (i}_{_{q0}}_{) . . . (i}_{_{q1}}_{′) . . . (i}_{_{qm−1}}_{) . . . (i}_{_{L−1}}₎^{(L-1)}, . . . ,v₍ᵢ_{₀}_{) . . . (i}_{_{q0}}_{′) . . . (i}_{_{q1}}_{′) . . . (i}_{_{qm−1}}_{′) . . . (i}_{_{L−1}}₎^{(L-1)}}): iⱼε[o,nⱼ−1]∀jε[0,L−1],(i_{q}_{ₖ}′ε[0,n_{q}_{ₖ}−1] [symbol] i_{q}_{ₖ}≠i_{q}_{ₖ}′)∀kε[0,m−1],0≦q₀≦q₁≦ . . . ≦qₘ₋₁, mε[2,L]} Eq. 52

The set P₄^{a} consists of all products formed from sets of vertices characterized by identical local indexes apart from those indexes at some index positions q₀, q₁, . . . , qₘ₋₁. For these index positions vertices take all possible different values from among the pairs of local indexes: (i_{q}_{₀}, i_{q}_{₀}′), (i_{q}_{₁}, i_{q}_{₁}′) , . . . , (i_{q}_{_{m−1}}, i_{q}_{_{m−1}}′). All possible 2^{m} local index sequences formed this way are included into the specification of the products of the set P₄^{a}. The number of index positions m for which vertices differ needs to be greater than, or equal to 2. The structure of the set P₄^{a} is very similar to the structure of the set of all products generated by our process

$${P}^{a} = {{⋃}_{i = 1}}^{4} {P}_{i}^{a} .$$

The set P^{a} of all products generated by executing the process CREATE_PRODUCTS is given by the expression in Eq. 53 below.

The expression in Eq. 53 is identical to Eq. 52 with one exception: The number of index positions m for which vertices differ may also take the values 0 and 1. The set P^{a} results from the union of P₁^{a}, P₂^{a}, P₃^{a} and P₄^{a}. It can be seen that by adding the elements of P₁^{a} into P₄^{a} one covers the case for which m=0. By further adding the elements of P₂^{a} and P₃^{a} into P₄^{a} also covers the case for which m=1.

P^{a}={P({v₍ᵢ_{₀}_{) . . . (i}_{_{q0}}_{) . . . (i}_{_{q1}}_{) . . . (i}_{_{qm−1}}_{) . . . (i}_{_{L−1}}₎^{(L-1)},v₍ᵢ_{₀}_{) . . . (i}_{_{q0}}_{′) . . . (i}_{_{q1}}_{) . . . (i}_{_{qm−1}}_{) . . . (i}_{_{L−1}}₎^{(L-1)},v₍ᵢ_{₀}_{) . . . (i}_{_{q0}}_{) . . . (i}_{_{q1}}_{′) . . . (i}_{_{qm−1}}_{) . . . (i}_{_{L−1}}₎^{(L-1)},v₍ᵢ_{₀}_{) . . . (i}_{_{q0}}_{′) . . . (i}_{_{q1}}_{′) . . . (i}_{_{qm−1}}_{) . . . (i}_{_{L−1}}₎^{(L-1)}, . . . ,v₍ᵢ_{₀}_{) . . . (i}_{_{q0}}_{′) . . . (i}_{_{q1}}_{′) . . . (i}_{_{qm−1}}_{′) . . . (i}_{_{L−1}}₎^{(L-1)}}): iⱼε[o,nⱼ−1]∀jε[0,L−1],(i_{q}_{ₖ}′ε[0,n_{q}_{ₖ}−1] [symbol] i_{q}_{ₖ}≠_{q}_{ₖ}′)∀kε[0,m−1],0≦q₀≦q₁≦ . . . ≦qₘ₋₁, mε[0,L]} Eq. 53

The expression in Eq. 53 is in a closed form that can be used for generating the products without performing spanning plane and spanning edge decomposition. In one embodiment all local index sequences defined in Eq. 53 are generated and form the products associated with these local index sequences. Spanning edges and spanning planes offer a graphical interpretation of the product generation process and can help with visualizing product generation for small operand sizes (e.g., N=9 or N=18).

The number of elements in the set pa generated by executing the process CREATE_PRODUCTS is equal to the number of scalar multiplications performed by generalized recursive Karatsuba for the same operand size N, and factors n₀, n₁, . . . , n_{L-1} such that N=n₀·n₁· . . . ·n_{L-1}.

This is true because the number of scalar multiplications performed by generalized recursive Karatsuba as defined by Paar and Weimerskirch is:

$$\begin{matrix}\vert {P}^{r} \vert = \frac{{n}_{0} \cdot ( {n}_{0} + 1 )}{2} \cdot \frac{{n}_{1} \cdot ( {n}_{1} + 1 )}{2} \cdot … \cdot \frac{{n}_{L - 1} \cdot ( {n}_{L - 1} + 1 )}{2} \\ = \frac{{\prod }_{i = 0}^{L - 1} {n}_{i} \cdot ( {n}_{i} + 1 )}{{2}^{L}}\end{matrix} \qquad Eq . 54$$

In Eq. 49-52 the sets P₁^{a}, P₂^{a}, P₃^{a} and P₄^{a} do not contain any common elements. Therefore, the cardinality |P^{a}| of the set P^{a} is given by:

$$\vert {P}^{a} \vert = {\sum }_{i = 1}^{4} \vert {P}_{i}^{a} \vert \qquad Eq . 55$$

The set P₁^{a} contains all products formed by sets which contain a single vertex only. Each single vertex is characterized by some arbitrary local index sequence. Hence the cardinality |P₁^{a}| of the set P₁^{a} is given by:

$$\vert {P}_{1}^{a} \vert = {n}_{0} \cdot {n}_{1} \cdot … \cdot {n}_{L - 1} = {\prod }_{i = 0}^{L - 1} {n}_{i} \qquad Eq . 56$$

The set P₂^{a} contains products formed by sets which contain two vertices. These vertices are characterized by identical local indexes for all index positions apart from the last one L−1. Since the number of all possible pairs of distinct values that can be considered from 0 to n_{L-1}−1 is n_{L-1}·(n_{L-1}−1)/2, the cardinality of the set P₂^{a} is equal to:

$$\vert {P}_{2}^{a} \vert = \frac{{n}_{0} \cdot {n}_{1} \cdot … \cdot {n}_{L - 1} \cdot ( {n}_{L - 1} )}{2} = ( {\prod }_{i = 0}^{L - 1} {n}_{i} ) \cdot \frac{( {n}_{L - 1} - 1 )}{2} \qquad Eq . 57$$

The set P₃^{a} contains products formed by sets which contain two vertices as well. The products of the set P₃^{a} are formed differently from P₂^{a}, however. The vertices that form the products of P₃^{a} are characterized by identical local indexes for all index positions apart from one position between 0 and L−2. Since the number of all possible pairs of local index values the can be considered for an index position j is nⱼ·(nⱼ−1)/2, the cardinality of the set P₃^{a} is equal to:

$$\begin{matrix}\vert {P}_{3}^{a} \vert = \frac{{n}_{0} \cdot ( {n}_{0} - 1 )}{2} \cdot {n}_{1} \cdot {n}_{2} \cdot … \cdot {n}_{L - 1} + \\ {n}_{0} \cdot \frac{{n}_{1} \cdot ( {n}_{1} - 1 )}{2} \cdot {n}_{2} \cdot … \cdot {n}_{L - 1} + … + \\ {n}_{0} \cdot {n}_{1} \cdot {n}_{2} \cdot … \cdot \frac{{n}_{L - 2} \cdot ( {n}_{L - 2} - 1 )}{2} \cdot {n}_{L - 1} \\ = ( {\prod }_{i = 0}^{L - 1} {n}_{i} ) \cdot {\sum }_{i = 0}^{L - 2} \frac{{n}_{i} - 1}{2}\end{matrix} \qquad Eq . 58$$

Finally, the set P₄^{a} is characterized by the expression in Eq. 52. The cardinality of the set P₄^{a} is equal to:

$$\vert {P}_{4}^{a} \vert = \frac{{n}_{0} \cdot ( {n}_{0} - 1 )}{2} \cdot \frac{{n}_{1} \cdot ( {n}_{1} - 1 )}{2} \cdot {n}_{2} \cdot {n}_{3} \cdot … \cdot {n}_{L - 1} + {n}_{0} \cdot \frac{{n}_{1} \cdot ( {n}_{1} - 1 )}{2} \cdot \frac{{n}_{2} \cdot ( {n}_{2} - 1 )}{2} \cdot {n}_{3} \cdot … \cdot {n}_{L - 1} + … + {n}_{0} \cdot {n}_{1} \cdot … \cdot \frac{{n}_{L - 2} \cdot ( {n}_{L - 2} - 1 )}{2} \cdot \frac{{n}_{L - 1} \cdot ( {n}_{L - 1} - 1 )}{2} + \frac{{n}_{0} \cdot ( {n}_{0} - 1 )}{2} \cdot \frac{{n}_{1} \cdot ( {n}_{1} - 1 )}{2} \cdot \frac{{n}_{2} \cdot ( {n}_{2} - 1 )}{2} \cdot {n}_{3} \cdot {n}_{4} \cdot … \cdot {n}_{L - 1} + \frac{{n}_{0} \cdot ( {n}_{0} - 1 )}{2} \cdot \frac{{n}_{1} \cdot ( {n}_{1} - 1 )}{2} \cdot {n}_{2} \cdot \frac{{n}_{3} \cdot ( {n}_{3} - 1 )}{2} \cdot {n}_{4} \cdot … \cdot {n}_{L - 1} + … + {n}_{0} \cdot {n}_{1} \cdot … \cdot \frac{{n}_{L - 3} \cdot ( {n}_{L - 3} - 1 )}{2} \cdot \frac{{n}_{L - 2} \cdot ( {n}_{L - 2} - 1 )}{2} \cdot \frac{{n}_{L - 1} \cdot ( {n}_{L - 1} - 1 )}{2} + … + \frac{{n}_{0} \cdot ( {n}_{0} - 1 )}{2} \cdot \frac{{n}_{1} \cdot ( {n}_{1} - 1 )}{2} \cdot … \cdot \frac{{n}_{L - 1} \cdot ( {n}_{L - 1} - 1 )}{2} \qquad Eq . 59$$

Summing up the cardinalities of the sets P₁^{a}, P₂^{a}, P₃^{a} and P₄^{a}:

$$\begin{matrix}\vert {P}^{a} \vert = {\sum }_{i = 1}^{4} \vert {P}_{i}^{a} \vert \\ = \frac{{n}_{0} \cdot {n}_{1} \cdot … \cdot {n}_{L - 1}}{{2}^{L}} \cdot \\ [ \begin{matrix}{2}^{L} + {2}^{L - 1} \cdot [ \begin{matrix}( {n}_{0} - 1 ) + ( {n}_{1} - 1 ) + \\ … + ( {n}_{L - 1} - 1 )\end{matrix} ] {2}^{L - 2} \cdot \\ [ \begin{matrix}( {n}_{0} - 1 ) \cdot ( {n}_{1} - 1 ) + ( {n}_{0} - 1 ) \cdot \\ ( {n}_{2} - 1 ) + … + ( {n}_{L - 2} - 1 ) \cdot \\ ( {n}_{L - 1} - 1 )\end{matrix} ] + \\ … + ( {n}_{0} - 1 ) \cdot ( {n}_{1} - 1 ) \cdot … \cdot ( {n}_{L - 1} - 1 )\end{matrix} ]\end{matrix} \qquad Eq . 60$$

To prove that |P^{r}|=|P^{a}| the identity that follows is used:

(a₀+k)·(a₁+k)· . . . ·(aₘ₋₁+k)=k^{m}+k^{m-1}·(a₀+a₁+ . . . +aₘ₋₁)+k^{m-2}·(a₀·a₁++a₀·a₂+ . . . +aₘ₋₂·aₘ₋₁)+ . . . +a₀·a₁· . . . ·aₘ₋₁ Eq. 61

By substituting aᵢ with (nᵢ−1), m with L, and k with 2 in Eq. 60 and by combining Eq. 60 and Eq. 61 results in Eq. 62:

$$\begin{matrix}\vert {P}^{a} \vert = \frac{{n}_{0} \cdot {n}_{1} \cdot … \cdot {n}_{L - 1}}{{2}^{L}} \cdot ( {n}_{0} - 1 + 2 ) \cdot ( {n}_{1} - 1 + 2 ) \cdot … \cdot \\ ( {n}_{L - 1} - 1 + 2 ) \\ = \frac{{\prod }_{i = 0}^{L - 1} {n}_{i} \cdot ( {n}_{i} + 1 )}{{2}^{L}} \\ = \vert {P}^{r} \vert\end{matrix} \qquad Eq . 62$$

Therefore, it is proven that the number of products generated by an embodiment process is equal to the number of multiplication performed by using a generalized recursive Karatsuba process. It should be noted that the number of products generated by an embodiment process is substantially smaller than the number of scalar multiplication performed by the one-iteration Karatsuba solution of Paar and Weimerskirch (A. Weimerskirch and C. Paar, “Generalizations of the Karatsuba Algorithm for Efficient Implementations”, Technical Report, University of Ruhr, Bochum, Germany, 2003), which is N·(N+1)/2.

A typical product p from the set P^{a} is

p={P({v₍ᵢ_{₀}_{) . . . (i}_{_{q0}}_{) . . . (i}_{_{q1}}_{) . . . (i}_{_{qm−1}}_{) . . . (i}_{_{L−1}}₎^{(L-1)},v₍ᵢ_{₀}_{) . . . (i}_{_{q0}}_{′) . . . (i}_{_{q1}}_{) . . . (i}_{_{qm−1}}_{) . . . (i}_{_{L−1}}₎^{(L-1)},v₍ᵢ_{₀}_{) . . . (i}_{_{q0}}_{) . . . (i}_{_{q1}}_{′) . . . (i}_{_{qm−1}}_{) . . . (i}_{_{L−1}}₎^{(L-1)},v₍ᵢ_{₀}_{) . . . (i}_{_{q0}}_{′) . . . (i}_{_{q1}}_{′) . . . (i}_{_{qm−1}}_{) . . . (i}_{_{L−1}}₎^{(L-1)}, . . . ,v₍ᵢ_{₀}_{) . . . (i}_{_{q0}}_{′) . . . (i}_{_{q1}}_{′) . . . (i}_{_{qm−1}}_{′) . . . (i}_{_{L−1}}₎^{(L-1)}}): iⱼε[o,nⱼ−1]∀jε[0,L−1],(i_{q}_{ₖ}′ε[0,n_{q}_{ₖ}−1] [symbol] i_{q}_{ₖ}≠_{q}_{ₖ}′)∀kε[0,m−1],0≦q₀≦q₁≦ . . . ≦qₘ₋₁,mε[0,L]} Eq. 63

For the product p, a ‘surface’ in the m-k dimensions (0≦k≦m) associated with ‘free’ index positions q_{f}_{₀}, q_{f}_{₁}, . . . , q_{f}_{_{m−k−1}}, ‘occupied’ index positions qₚ_{₀}, qₚ_{₁}, . . . , qₚ_{_{k−1}} and indexes for the occupied positions î_{q}_{ₚ₀}, î_{q}_{ₚ₁}, . . . , î_{q}_{_{pk−1}} is defined as the product that derives from p by setting the local indexes of all vertices of p to be equal to î_{q}_{ₚ₀}, î_{q}_{ₚ₁}, . . . , î_{q}_{_{pk−1}} at the occupied index positions, and by allowing the indexes at the free positions to take any value between i_{q}_{_{f0}} and i_{q}_{_{f0}}′, i_{q}_{_{f1}} and i_{q}_{_{f1}}′, . . . , i_{q}_{_{fm−k−1}} and i_{q}_{_{fm−k−1}}′.

The sets of the free and occupied index positions satisfy the following conditions:

{q_{f}_{₀},q_{f}_{₁}, . . . ,q_{f}_{_{m−k−1}}}⊂{q₀,q₁, . . . ,qₘ₋₁},

{qₚ_{₀},qₚ_{₁}, . . . ,qₚ_{_{k−1}}}⊂{q₀,q₁, . . . ,qₘ₋₁},

{i q_{f}_{₀},q_{f}_{₁},q_{f}_{_{m−k−1}}}∩{qₚ_{₀},qₚ_{₁}, . . . ,qₚ_{_{k−1}}}=Ø,

{q_{f}_{₀},q_{f}_{₁},qₚ_{_{m−k−1}}}∪{qₚ_{₀},qₚ_{₁}, . . . ,qₚ_{_{k−1}}}={q₀,q₁, . . . ,qₘ₋₁} Eq. 64

In addition the indexes for the occupied positions î_{q}_{ₚ₀}, î_{q}_{_{q1}}, . . . , î_{q}_{_{pk−1}} satisfy:

î_{q}_{ₚ₀}ε{i_{q}_{ₚ₀},î_{q}_{ₚ₀}′}, i_{q}_{ₚ₁}ε{i_{q}_{ₚ₁},i_{q}_{ₚ₁}′}, . . . , î_{q}_{_{pk−1}}ε{i_{q}_{ₚ₁},i_{q}_{_{pk−1}}′} Eq. 65

Such surface is denoted as

$${u}_{{q}_{{f}_{0}} , {q}_{{f}_{1}} , … , {q}_{{f}_{m - k - 1}} ; {q}_{p 0} , {q}_{p 1} , … , {q}_{{p}_{k - 1}}}^{p ; m - k ; {{i}^{⋒}}_{{q}_{p 0}} , {{i}^{⋒}}_{{q}_{p 1}} , … , {{i}^{⋒}}_{{q}_{{p}_{k - 1}}}} .$$

### The formal definition of a surface

$${u}_{{q}_{{f}_{0}} , {q}_{{f}_{1}} , … , {q}_{{f}_{m - k - 1}} ; {q}_{p 0} , {q}_{p 1} , … , {q}_{{p}_{k - 1}}}^{p ; m - k ; {{i}^{⋒}}_{{q}_{p 0}} , {{i}^{⋒}}_{{q}_{p 1}} , … , {{i}^{⋒}}_{{q}_{{p}_{k - 1}}}}$$

is given in Eq. 66 below.

From the definition of Eq. 66 is it evident that a surface

$${u}_{{q}_{{f}_{0}} , {q}_{{f}_{1}} , … , {q}_{{f}_{m - k - 1}} ; {q}_{p 0} , {q}_{p 1} , … , {q}_{{p}_{k - 1}}}^{p ; m - k ; {{i}^{⋒}}_{{q}_{p 0}} , {{i}^{⋒}}_{{q}_{p 1}} , … , {{i}^{⋒}}_{{q}_{{p}_{k - 1}}}}$$

associated with a product p is also an element of the set P^{a} and is generated by the procedure CREATE_PRODUCTS. From the definition in Eq. 66 is it is also evident that whereas p is formed by a set of 2^{m} vertices, the surface

$${u}_{{q}_{{f}_{0}} , {q}_{{f}_{1}} , … , {q}_{{f}_{m - k - 1}} ; {q}_{p 0} , {q}_{p 1} , … , {q}_{{p}_{k - 1}}}^{p ; m - k ; {{i}^{⋒}}_{{q}_{p 0}} , {{i}^{⋒}}_{{q}_{p 1}} , … , {{i}^{⋒}}_{{q}_{{p}_{k - 1}}}}$$

is formed by a set of 2^{m-k} vertices. Finally, from the definition of the mapping in Eq. 43 and Eq. 66 it is evident that

$${u}_{{q}_{{f}_{0}} , {q}_{{f}_{1}} , … , {q}_{{f}_{m - k - 1}} ; {q}_{p 0} , {q}_{p 1} , … , {q}_{{p}_{k - 1}}}^{p ; m - k ; {{i}^{⋒}}_{{q}_{p 0}} , {{i}^{⋒}}_{{q}_{p 1}} , … , {{i}^{⋒}}_{{q}_{{p}_{k - 1}}}} < p .$$

$${u}_{{q}_{{f}_{0}} , {q}_{{f}_{1}} , … , {q}_{{f}_{m - k - 1}} ; {q}_{p 0} , {q}_{p 1} , … , {q}_{{p}_{k - 1}}}^{p ; m - k ; {{i}^{⋒}}_{{q}_{p 0}} , {{i}^{⋒}}_{{q}_{p 1}} , … , {{i}^{⋒}}_{{q}_{{p}_{k - 1}}}} = P ( \{ \begin{matrix}{v}_{( {i}_{0} ) … ( {{i}^{⋒}}_{{q}_{{p}_{0}}} ) … ( {i}_{{q}_{{f}_{0}}} ) … ( {i}_{{q}_{{f}_{1}}} ) … ( {i}_{{q}_{{f}_{m - k - 1}}} ) … ( {{i}^{⋒}}_{{q}_{{p}_{k - 1}}} ) … ( {i}_{L - 1} )}^{( L - 1 )} , \\ {v}_{( {i}_{0} ) … ( {\hat{i}}_{{q}_{{p}_{0}}} ) … ( {i}_{{q}_{{f}_{0}}}^{′} ) … ( {i}_{{q}_{{f}_{1}}} ) … ( {i}_{{q}_{{f}_{m - k - 1}}} ) … ( {{i}^{⋒}}_{{q}_{{p}_{k - 1}}} ) … ( {i}_{L - 1} )}^{( L - 1 )} , \\ {v}_{( {i}_{0} ) … ( {{i}^{⋒}}_{{q}_{{p}_{0}}} ) … ( {i}_{{q}_{{f}_{0}}} ) … ( {i}_{{q}_{{f}_{1}}}^{′} ) … ( {i}_{{q}_{{f}_{m - k - 1}}} ) … ( {{i}^{⋒}}_{{q}_{{p}_{k - 1}}} ) … ( {i}_{L - 1} )}^{( L - 1 )} , \\ {v}_{( {i}_{0} ) … ( {\hat{i}}_{{q}_{{p}_{0}}} ) … ( {i}_{{q}_{{f}_{0}}}^{′} ) … ( {i}_{{q}_{{f}_{1}}}^{′} ) … ( {i}_{{q}_{{f}_{m - k - 1}}} ) … ( {{i}^{⋒}}_{{q}_{{p}_{k - 1}}} ) … ( {i}_{L - 1} )}^{( L - 1 )} , … , \\ {v}_{( {i}_{0} ) … ( {\hat{i}}_{{q}_{{p}_{0}}} ) … ( {i}_{{q}_{{f}_{0}}}^{′} ) … ( {i}_{{q}_{{f}_{1}}}^{′} ) … ( {i}_{{q}_{{f}_{m - k - 1}}} ) … ( {{i}^{⋒}}_{{q}_{{p}_{k - 1}}} ) … ( {i}_{L - 1} )}^{( L - 1 )}\end{matrix} \} ) \text{:} \\ \{ {i}_{{q}_{{f}_{0}}} , {i}_{{q}_{{f}_{1}}} , … , {i}_{{q}_{{f}_{m - k - 1}}} \} ∈ \{ {i}_{{q}_{0}} , {i}_{{q}_{1}} , … , {i}_{{q}_{m - 1}} \} , \\ \{ {i}_{{q}_{{f}_{0}}}^{′} , {i}_{{q}_{{f}_{1}}}^{′} , … , {i}_{{q}_{{f}_{m - 1}}}^{′} \} ∈ \{ {i}_{{q}_{0}}^{′} , {i}_{{q}_{1}}^{′} , … , {i}_{{q}_{m - 1}}^{′} \} \\ and conditions ( 65 ) and ( 66 ) hold \} \qquad Eq . 66$$

The set of all surfaces in the m-k dimensions associated with a product p, free index positions q_{f}_{₀}, q_{f}_{₁}, . . . , q_{f}_{_{m−k−1}} and occupied index positions qₚ_{₀}, qₚ_{₁}, . . . , qₚ_{_{k−1}} are defined as the union:

$${U}_{{q}_{{f}_{0}} , {q}_{{f}_{1}} , … , {q}_{{f}_{m - k - 1}} ; {q}_{{p}_{0}} , {q}_{{p}_{1}} , … , {q}_{{p}_{k - 1}}}^{p ; m - k} = {⋃}_{{\overline{i}}_{{q}_{{p}_{0}}} , {\overline{i}}_{{q}_{{p}_{1}}} , … , {\overline{i}}_{{q}_{{p}_{k - 1}}}} {u}_{{q}_{{f}_{0}} , {q}_{{f}_{1}} , … , {q}_{{f}_{m - k - 1}} ; {q}_{{p}_{0}} , {q}_{{p}_{1}} , … , {q}_{{p}_{k - 1}}}^{p ; m - k ; {\overline{i}}_{{q}_{{p}_{0}}} , {\overline{i}}_{{q}_{{p}_{1}}} , … , {\overline{i}}_{{q}_{{p}_{k - 1}}}} \qquad Eq . 67$$

Next, the set of all surfaces in the m-k dimensions associated with a product p are defined as the union:

$${U}^{p ; m - k} = {⋃}_{{{q}_{{f}_{0}} , {q}_{{f}_{1}} , … , {q}_{{f}_{m - k - 1}} ,}_{{q}_{{p}_{0}} , {q}_{{p}_{1}} , … , {q}_{{p}_{k - 1}}}} {U}_{{q}_{{f}_{0}} , {q}_{{f}_{1}} , … , {q}_{{f}_{m - k - 1}} ; {q}_{{p}_{0}} , {q}_{{p}_{1}} , … , {q}_{{p}_{k - 1}}}^{p ; m - k} \qquad Eq . 68$$

A ‘parent’ surface [symbol] (u) of a particular surface

$$u = {u}_{{q}_{{f}_{0}} , {q}_{{f}_{1}} , … , {q}_{{f}_{m - k - 1}} ; {q}_{p 0} , {q}_{p 1} , … , {q}_{{p}_{k - 1}}}^{p ; m - k ; {{i}^{⋒}}_{{q}_{p 0}} , {{i}^{⋒}}_{{q}_{p 1}} , … , {{i}^{⋒}}_{{q}_{{p}_{k - 1}}}}$$

is defined as the surface associated with the product p, occupied index positions qₚ_{₀}, qₚ_{₁}, . . . , qₚ_{_{k−2}} free index positions q_{f}_{₀}, q_{f}_{₁}, . . . , q_{f}_{_{k−m−1}}, qₚ_{_{k−1}}, and indexes at the occupied positions î_{q}_{ₚ₁}, . . . , î_{q}_{_{pk−2}}:

$$℘ ( u ) = {u}_{{q}_{{f}_{0}} , {q}_{{f}_{1}} , … , {q}_{{f}_{m - k - 1}} , {q}_{{p}_{k - 1}} ; {q}_{p 0} , {q}_{p 1} , … , {q}_{{p}_{k - 2}}}^{p ; m - k + 1 ; {{i}^{⋒}}_{{q}_{p 0}} , {{i}^{⋒}}_{{q}_{p 1}} , … , {{i}^{⋒}}_{{q}_{{p}_{k - 2}}}} \qquad Eq . 69$$

The set of ‘children’ of a surface uεU^{p;m-k} is defined as the set:

l(u)={v:vεU^{p;m-k-1},u= [symbol] (v)} Eq. 70

In one embodiment, a process that generates subtraction formulae uses a matrix M which size is equal to the cardinality of P^{a}, i.e., the number of all products generated by the procedure CREATE_PRODUCTS( ). The cardinality of P^{a} is also equal to the number of unique surfaces that can be defined in all possible dimensions for all products of P^{a}. This is because each surface of a product is also a product by itself. For each possible product p, or surface u, the matrix M is initialized as M[p]←p, or equivalently M[u]←u. Initialization takes place every time a set of subtractions is generated for a product p of P^{a}.

Subtractions are generated by a generate subtractions process GENERATE_SUBTRACTIONS( ), which pseudo code is listed below. The subtraction formulae which are generated by generate subtractions process GENERATE_SUBTRACTIONS( ) are returned in the set S^{a}.

1. GENERATE_SUBTRACTIONS( )
2. S^{a} ← Ø
3. for every p ∈ P^{a}
4. do INIT_M( )
5. GENERATE_SUBTRACTIONS_FOR_PRODUCT(p)
6. return S^{a}

The procedure INIT_M( ) is listed below:

INIT_M( )
1. for every p ∈ P^{a}
2. do M[p] ← p
3. return

A process GENERATE_SUBTRACTIONS_FOR_PRODUCT( ), that is also invoked by GENERATE_SUBTRACTIONS( ), is listed below in pseudo code:

GENERATE_SUBTRACTIONS_FOR_PRODUCT(p)
1. m ← the number free index positions in p
2. for l ← 0 to m−1
3. for every uᵢ ∈ U^{p;l}
4.
5. do s ← (M[ [symbol] (uᵢ)] ← M[ [symbol] (uᵢ)] − M[uᵢ])
6. if s ∉ S^{a}
7. then
8. S^{a} ← S^{a} ∪ s
9. return

For each product p of P^{a} the subtractions generated by a process GENERATE_SUBTRACTIONS( ) reduce its value. Let μ(p) the final value of the table entry M[p] after the procedure GENERATE_SUBTRACTIONS_FOR_PRODUCT( ) is executed for the product p. It can be seen that μ(p) is in fact the product p minus all surfaces of p defined in the m−1 dimensions, plus all surfaces of p defined in the m−2 dimensions, . . . , minus (plus) all surfaces of p defined in 0 dimensions (i.e., products of single vertices). By m it is meant that the number of free index positions of p.

Next, it is determined how the subtractions generated by the process GENERATE_SUBTRACTIONS( ) can be interpreted graphically. Consider an example of an 18 by 18 multiplication. One of the products generated by the procedure CREATE_PRODUCTS( ) is formed from the set of vertices with global indexes 0, 1, 6, 7, 9, 10, 15, 16. This is the product (a₀+a₁+a₆+a₇+a₉+a₁₀+a₁₅+a₁₆)□(b₀+b₁+b₆+b₇+b₉+b₁₀+b₁₅+b₁₆).

Consider the complete graph which is formed from the vertices of this product. This graph has the shape of a cube but it also contains the diagonals that connect every other vertex, as shown in FIG. 13. The product has 6 associated surfaces defined in 2 dimensions, 12 surfaces defined in 1 dimension and 8 surfaces defined in 0 dimensions. The surfaces defined in 2 dimensions are the products (a₀+a₁+a₆+a₇)·(b₀+b₁+b₆+b₇), (a₀+a₁+a₉+a₁₀)·(b₀+b₁+b₉+b₁₀), (a₆+a₇+a₁₅+a₁₆)·(b₆+b₇+b₁₅+b₁₆), (a₉+a₁₀+a₁₅+a₁₆)·(b₉+b₁₀+b₁₅+b₁₆), (a₁+a₇+a₁₀+a₁₆)·(b₁+b₇+b₁₀+b₁₆), and (a₀+a₆+a₉+a₁₅)·(b₀+b₆+b₉+b₁₅). These products are formed from sets of 4 vertices. The complete graphs of these sets form squares which together with their diagonals cover the cube associated with the product (a₀+a₁+a₆+a₇+a₉+a₁₀+a₁₅+a₁₆)·(b₀+b₁+b₆+b₇+b₉+b₁₀+b₁₅+b₁₆). This is the reason why the term ‘surfaces’ is used to refer to such products.

The surfaces defined in a single dimension are the products (a₀+a₁)·(b₀+b₁), (a₀+a₆)·(b₀+b₆), (a₁+a₇)·(b₁+b₇), (a₆+a₇)·(b₆+b₇), (a₉+a₁₀)·(b₉+b₁₀), (a₉+a₁₅)·(b₉+b₁₅), (a₁₀+a₁₆)·(b₁₀+b₁₆), (a₁₅+a₁₆)·(b₁₅+b₁₆), (a₁+a₁₀)·(b₁+b₁₀), (a₀+a₉)·(b₀+b₉), (a₇+a₁₆)·(b₇+b₁₆), and (a₆+a₁₅)·(b₆+b₁₅). These products are formed from sets of 2 vertices. The complete graphs of these sets form the edges of the cube associated with the product (a₀+a₁+a₆+a₇+a₉+a₁₀+a₁₅+a₁₆)·(b₀+b₁+b₆+b₇+b₉+b₁₀+b₁₅+b₁₆). Finally, the surfaces defined in 0 dimensions are products formed from single vertices. These are the products a₀·b₀, a₁·b₁, a₆·b₆, a₇·b₇, a₉·b₉, a₁₀·b₁₀, a₁₅·b₁₅, and a₁₆·b₁₆.

Next, it is determined what remains if from the product (a₀+a₁+a₆+a₇+a₉+a₁₀+a₁₅+a₁₆)·(b₀+b₁+b₆+b₇+b₉+b₁₀+b₁₅+b₁₆) are subtracted all the surfaces defined in 2 dimensions, added all surfaces defined in 1 dimension and subtracted all surfaces defined in 0 dimensions. It can be seen that what remains is the term a₀·b₁₆+a₁₆·b₀+a₁·b₁₅+a₁₅·b₁+a₆·b₁₀+a₁₀·b₆+a₉·b₇+a₇·b₉. This term is part of the coefficient c₁₆ of the output. The derivation of this term can be interpreted graphically as the subtraction of all covering squares from a cube, the addition of its edges and the subtraction of its vertices. What remains from these subtractions are the diagonals of the cube, excluding their end-points.

To prove the correctness of the embodiments, it is shown that every term μ(p) produced by the subtractions of the process GENERATE_SUBTRACTIONS( ) is part of one coefficient of a Karatsuba output c(x). It is also shown that for two different products p, \tilde{p}εP^{a}, the terms μ(p) and μ(\tilde{p}) do not include common terms of the form aᵢ_{₁}·bᵢ_{₂}+aᵢ_{₂}·bᵢ_{₁}. Also, it is shown that each term of the form a_{I}_{₁}·b_{I}_{₂}+a_{I}_{₂}·b_{I}_{₁} of every coefficient of the Karatsuba output c(x) is part of some term μ(p) resulting from a product pεP^{a}.

Consider a product pεP^{a} defined by Eq. 63. If m>0, then μ(p) is the sum of all possible terms of the form a_{I}_{₁}·b_{I}_{₂}+a_{I}_{₂}·b_{I}_{₁} that satisfy the following conditions:

I₁=i₀·n₁· . . . ·n_{L-1}+ . . . +î_{q}_{₀}·n_{q}_{₀}₊₁· . . . ·nₗ₋₁+ . . . +î_{q}_{_{m−1}}·n_{q}_{_{m−1}}₊₁· . . . ·nₗ₋₁+ . . . +i_{L-1},

I₂=i₀·n₁· . . . ·n_{L-1}+ . . . +\check{i}_{q}_{₀}·n_{q}_{₀}₊₁· . . . ·nₗ₋₁+ . . . +\check{i}_{q}_{_{m−1}}·n_{q}_{_{m−1}}₊₁· . . . ·nₗ₋₁+ . . . +i_{L-1},

î_{q}_{₀},\check{i}_{q}_{₀}ε{i_{q}_{₀},i_{q}_{₀}′},î_{q}_{₀}≠\check{i}_{q}_{₀}, . . . ,î_{q}_{_{m−1}},\check{i}_{q}_{_{m−1}}ε{i_{q}_{_{m−1}},i_{q}_{_{m−1}}′},î_{q}_{_{m−1}}≠\check{i}_{q}_{_{m−1}} Eq. 71

This means that μ(p) is the sum of all terms of the form a_{I}_{₁}·b_{I}_{₂}+a_{I}_{₂}·b_{I}_{₁} such that the global index I₁ in each term a_{I}_{₁}·b_{I}_{₂}+a_{I}_{₂}·b_{I}_{₁} is created by selecting some local index values î_{q}_{₀}, . . . , î_{q}_{_{m−1}} from among {i_{q}_{₀},i_{q}_{₀}′}, . . . , {i_{q}_{_{m−1}},i_{q}_{_{m−1}}′}, whereas the global index I₂ in the same term is created by selecting those local index values not used by I₁.

From Eq. 63 it is evident that the product p is the sum of terms which are either of the form a_{I}_{₁}·b_{I}_{₂}+a_{I}_{₂}·b_{I}_{₁} or a_{I}_{₁}·b_{I}_{₁}. The term μ(p) is derived from p by sequentially subtracting and adding surfaces of m−1, m−2, . . . , 0 dimensions. These surfaces are also sums of terms of the forms a_{I}_{₁}·b_{I}_{₂}+a_{I}_{₂}·b_{I}_{₁} or a_{I}_{₁}·b_{I}_{₁} (from Eq. 66). In addition every term of the forms a_{I}_{₁}·b_{I}_{₂}+a_{I}_{₂}·b_{I}_{₁} or a_{I}_{₁}·b_{I}_{₁} of every surface of p is included in p.

Next, it is shown that μ(p) does not contain terms of the form a_{I}_{₁}·b_{I}_{₁} and that the terms of the form a_{I}_{₁}·b_{I}_{₂}+_{I}_{₂}·b_{I}_{₁} satisfy Eq. 71. Assume for the moment that there exist a term a_{I}_{₁}·b_{I}_{₂}+a_{I}_{₂}·b_{I}_{₁} in μ(p) that does not satisfy Eq. 71. For this term, there exists a subset of local index positions {qₑ_{₀}, qₑ_{₁}, . . . , qₑ_{_{l−1}}}ε{q₀, q₁, . . . , qₘ₋₁} for which the global indexes I₁ and I₂ are associated with the same local index values. Because of this reason this term is part of

$$( \begin{matrix}l \\ l\end{matrix} )$$

surfaces of m dimensions,

$$( \begin{matrix}l \\ l - 1\end{matrix} )$$

surfaces of m−1 dimensions,

$$( \begin{matrix}l \\ l - 2\end{matrix} )$$

surfaces of m−2 dimensions, . . . , and

$$( \begin{matrix}l \\ 0\end{matrix} )$$

surfaces of m−l dimensions. From the manner in which the mapping P(V) is defined, it evident that the term a_{I}_{₁}·b_{I}_{₂}+a_{I}_{₂}·b_{I}_{₁} appears only once in each of these surfaces. Therefore the total number of times N_{L} this term appears in μ(p) is given by:

$${N}_{L} = \vert \begin{matrix}( \begin{matrix}l \\ l\end{matrix} ) - ( \begin{matrix}l \\ l - 1\end{matrix} ) + ( \begin{matrix}l \\ l - 2\end{matrix} ) - … + \\ {( - 1 )}^{l} \cdot ( \begin{matrix}l \\ 1\end{matrix} ) - {( - 1 )}^{l} \cdot ( \begin{matrix}l \\ 0\end{matrix} )\end{matrix} \vert \qquad Eq . 72$$

Using Newton's binomial formula:

$${( x + a )}^{n} = {a}^{n} + ( \begin{matrix}n \\ 1\end{matrix} ) \cdot {a}^{n - 1} \cdot x + ( \begin{matrix}n \\ 2\end{matrix} ) \cdot {a}^{n - 2} \cdot {x}^{2} + … + ( \begin{matrix}n \\ 1\end{matrix} ) \cdot a \cdot {x}^{n - 1} + {x}^{n} \qquad Eq . 73$$

Substituting x with 1, a with −1 and n with l we get that N_{L}=0. Hence μ(p) does not contain any terms of the form a_{I}_{₁}·b_{I}_{₂}+a_{I}_{₂}·b_{I}_{₁} that do not satisfy Eq. 72. What remains is to show that μ(p) does not contain terms of the form a_{I}_{₁}·b_{I}_{₁}. Every term of the form a_{I}_{₁}·b_{I}_{₁} is part of

$$( \begin{matrix}m \\ m\end{matrix} )$$

surfaces of m dimensions,

$$( \begin{matrix}m \\ m - 1\end{matrix} )$$

surfaces of m−1 dimensions,

$$( \begin{matrix}m \\ m - 2\end{matrix} )$$

surfaces of m−2 dimensions, . . . , and

$$( \begin{matrix}m \\ 0\end{matrix} )$$

surfaces of 0 dimensions. Therefore, the total number of times a term a_{I}_{₁}·b_{I}_{₁} appears in μ(p) is zero (from Newton's binomial formula).

The term μ(p) contains all possible terms of the form a_{I}_{₁}·b_{I}_{₂}+a_{I}_{₂}·b_{I}_{₁} that satisfy Eq. 71. This is because these terms are part of p and they are not included into any surface of p. Therefore, these terms are not subtracted out when μ(p) is derived.

Consider a product pεP^{a} defined by Eq. 63. The sum of terms μ(p) is part of the coefficient cᵢ_{_{c}} of the Karatsuba output where the index i_{c} is given by Eq. 74.

First consider the case where m>0. In this case, μ(p) is a sum of terms of the form a_{I}_{₁}·b_{I}_{₂}+a_{I}_{₂}·b_{I}_{₁} that satisfy Eq. 71. In this case I₁+I₂=i_{c} for every term a_{I}_{₁}·b_{I}_{₂}+a_{I}_{₂}·b_{I}_{₁}. In the second case where m=0, the product p is formed from a single vertex. Therefore, p=μ(p)=a_{I}_{₁}·b_{I}_{₁}, for some global index I₁. In this case, 2·I₁=i_{c}.

$${i}_{c} = 2 \cdot {i}_{0} \cdot {n}_{1} \cdot {n}_{2} \cdot … \cdot {n}_{L - 1} + … + ( {i}_{{q}_{0}} + {i}_{{q}_{0}}^{′} ) \cdot {n}_{{q}_{0} + 1} \cdot {n}_{{q}_{0} + 2} \cdot … \cdot {n}_{L - 1} + … + ( {i}_{{q}_{1}} + {i}_{{q}_{1}}^{′} ) \cdot {n}_{{q}_{1} + 1} \cdot {n}_{{q}_{1} + 2} \cdot … \cdot {n}_{L - 1} + … + ( {i}_{{q}_{m - 1}} + {i}_{{q}_{m - 1}}^{′} ) \cdot {n}_{{q}_{m - 1} + 1} \cdot {n}_{{q}_{m - 1} + 2} \cdot … \cdot {n}_{L - 1} + … + 2 \cdot {i}_{L - 1} \qquad Eq . 74$$

Next we show that the terms μ(p) and μ(\tilde{p}) that derive from two different products p, \tilde{p}εP^{a} do not include any common terms.

Consider the products p, \tilde{p}εP^{a}. The terms μ(p) and μ(\tilde{p}) that derive from these products have no terms of the form a_{I}_{₁}·b_{I}_{₂}+a_{I}_{₂}·b_{I}_{₁} or a_{I}_{₁}·b_{I}_{₁} in common.

In the trivial case where the number of free index positions of both p and \tilde{p} is zero, p=μ(p), \tilde{p}=μ(\tilde{p}) and p≠\tilde{p}. In the case where one of the two products is characterized by zero free index positions and the other is not, then it is not possible for μ(p), μ(\tilde{p}) to contain common terms since one of the two is equal to a_{I}_{₁}·b_{I}_{₁} or some global index I₁ and the other is the sum of terms a_{I}_{₁}·b_{I}_{₂}+a_{I}_{₂}·b_{I}_{₁} that satisfy Eq. 72.

Now, assume that both p and \tilde{p} are characterized by at least one free index position and that there exist two terms a_{I}_{₁}·b_{I}_{₂}+a_{I}_{₂}·b_{I}_{₁} and a_{Ĩ}_{₁}·b_{Ĩ}_{₂}+a_{Ĩ}_{₂}·b_{Ĩ}_{₁} from μ(p) and μ(\tilde{p}) respectively that are equal. Equality of global indexes means equality of their associated sequences of local indexes. The local index positions for which I₁ and I₂ (or Ĩ₁ and Ĩ₂) differ are free index positions for both p and \tilde{p}. On the other hand, all other local index positions must be occupied. Indeed, if any of these index positions was free, then the local index sequences associated with I₁ and I₂ would differ at that position, but they do not. Therefore, the products p and \tilde{p} are defined using the same free and occupied local index positions. Now, from the equality of the local index sequences of I₁ and I₂ it is evident that p and \tilde{p} specify the same pairs of local index values at their free index positions and the same single values at their occupied positions. Therefore, p and \tilde{p} are equal, which contradicts the assumption.

Every term of the form a_{I}_{₁}·b_{I}_{₂}+a_{I}_{₂}·b_{I}_{₁} of a coefficient of the Karatsuba output is part of a term μ(p) for some product pεP^{a}. The global indexes I₁ and I₂ can be converted into 2 local index sequences. These sequences will be identical for some local index positions and different for others. A product p can be completely defined in this case from I₁ and I₂ by specifying the local index positions for which I₁ and I₂ differ as free and all others as occupied. The pairs of local index values for which I₁ and I₂ differ are specified at the free index positions of all vertices of the product p, whereas the local index values which are in common between I₁ and I₂ are specified at the occupied positions. From the manner in which the product p is specified it is evident that μ(p) contains the term a_{I}_{₁}·b_{I}_{₂}+a_{I}_{₂}·b_{I}_{₁}.

In what follows we refer to the example of FIG. 14B. We describe the steps by which a single iteration multiplication is performed between two polynomials of degree 8. Additions connect the “a” terms and the “b” terms 6, 7 and 8 in order to form the nodes of the triangle 6-7-8. Additions connect the “a” terms and the “b” terms 3, 4 and 5 to form the triangle 3-4-5. Additions connect the “a” terms and the “b” terms 0, 1 and 2 for form the triangle 0-1-2. Additions connect 1-by-1 the “a” and “b” terms 6-7-8 and 3-4-5. Additions connect 1-by-1 the “a” and “b” terms 6-7-8 and 0-1-2. Additions connect 1-by-1 the “a” and “b” terms 3-4-5 and 0-1-2. Additions create the spanning planes associated the edges of the triangles 6-7-8 and 3-4-5. Additions create the spanning planes associated with the edges of the triangles 6-7-8 and 0-1-2. Additions create the spanning planes associated with the edges of the edges of the triangles 3-4-5 and 0-1-2.

Multiplications create the nodes of the triangles 0-1-2, 3-4-5, and 6-7-8. Multiplications create the edges of the triangle 6-7-8. Multiplications create the edges of the triangle 3-4-5. Multiplications create the edges of the triangle 0-1-2. Multiplications create the edges that connect the nodes of the triangles 6-7-8 and 3-4-5. Multiplications create the edges that connect the nodes of the triangles 6-7-8 and 0-1-2. Multiplications create the edges that connect the nodes of the triangles 3-4-5 and 0-1-2. Multiplications create the spanning planes that connect the edges of the triangles 6-7-8 and 3-4-5. Multiplications create the spanning planes that connect the edges of the triangles 6-7-8 and 0-1-2. Multiplications create the spanning planes that connect the edges of the triangles 3-4-5 and 0-1-2.

Subtractions are performed, associated with the edges of the triangle 6-7-8. Subtractions are performed, associated with the edges of the triangle 3-4-5. Subtractions are performed, associated with the edges of the triangle 0-1-2. Subtractions are performed, associated with the edges that connect the nodes of the triangles 6-7-8 and 3-4-5. Subtractions are performed, associated with the edges that connect the nodes of the triangles 6-7-8 and 0-1-2. Subtractions are performed, associated with the edges that connect the nodes of the triangles 3-4-5 and 0-1-2. Subtractions are performed, associated with the spanning planes that connect the edges of the triangles 6-7-8 and 3-4-5. Subtractions are performed, associated with the spanning planes that connect the edges of the triangles 6-7-8 and 0-1-2. Finally, subtractions are performed, associated with the spanning planes that connect the edges of the triangles 3-4-5 and 0-1-2.

Additions create the coefficients of the resulting polynomial. Next the polynomial is converted to a big number. In one embodiment multiplications are performed between numbers which are 64-bits long and additions are performed between numbers which are 128-bits long using the following assembly code:

```
#define add128(s2,s1,a2,a1)  \
_asm_{—}  \
  ( “addq %5, %1\n\t” \
    “adcq %4, %0” \
  : “=r” (s1) , “=r” (s2)  \
  : “0” (s1) , “1” (s2),  \
    “g” (a1) , “g” (a2)  \
  );
#define sub128(s2,s1,a2,a1)  \
_asm_{—}  \
  ( “subq %5, %1,\n\t” \
    “sbbq %4, %0” \
  : “=r” (s1) , “=r” (s2)  \
  : “0” (s1) , “1” (s2),  \
    “g” (a1) , “g” (a2)  \
  );
#define mul128(p2,p1,f1,f2)  \
_asm_{—}  \
  ( “mulq %3” \
    : “=d” (p1) , “=a” (p2)  \
    : “a” (f1) , “rm” (f2)  \
  );
```

FIG. 14A-B illustrates a block diagram and graphical illustration of process of an embodiment. Process 1400 starts with block 1405 where the number of coefficients of operands are expressed as a product of factors. It should be noted that the graphical illustration is an example for a 9×9 operation. In block 1410, each of the factors is associated with a level in a hierarchy of interconnected graphs. At each level of the hierarchy, a fully connected graph (i.e., generalized graphs having generalized vertices and generalized edges) has as many vertices as the factor associated with the level. At the last level of the hierarchy there exist simple graphs with simple interconnected vertices and simple edges.

In block 1415, each simple vertex is associated with a global index and a last level local index. In block 1420, generalized edges are defined consisting of a number of spanning edges and spanning planes. In block 1425, a spanning edge is an edge between two corresponding generalized (or simple) vertices. Corresponding vertices are associated with the same last level local index but different global indexes. A spanning plane is a fully connected graph interconnecting four generalized (or simple) vertices.

In block 1430, for all graphs interconnecting simple vertices, the products associated with simple vertices and simple edges are determined. Block 1435 starts a loop between blocks 1440, 1445, 1450 and 1460, where each block is performed for all generalized edges at each level.

In block 1440, a generalized edge is decomposed into its constituent spanning edges and spanning planes. In block 1445, the products associated with spanning edges are determined. If a spanning edge connects simple vertices, the product associated with the edge from the global indexes of the edge's adjacent vertices is formed. Otherwise the products associated with spanning edges are determined by treating each spanning edge as a generalized edge and applying a generalized edge process (blocks 1440 and 1445) recursively.

In block 1450, to determine products associated with spanning planes, process 1400 examines if the vertices of the plane are simple or not. If they are simple, the product associated with the global indexes of the planes vertices is formed and returned. If the vertices are not simple, the generalized vertices are expanded into graphs and sets of corresponding vertices and edges are created. Corresponding edges are edges interconnecting vertices with the same last level local index but different global index. For each set, the vertices which are elements of the set are used for running the spanning plane process (block 1450) recursively.

In block 1460, it is determined whether the last generalized edge has been processed by blocks 1440, 1445 and 1450. If the last edge has not been processed, process 1400 returns to block 1440. If the last edge has been processed, process 1400 continues with block 1465. In block 1465, for all the graphs associated with products created, (i.e., edges, squares, cubes, hyper-cubes, etc.) the periphery is subtracted and the diagonals are used to create coefficients of a final product. Process 1400 then proceeds with returning the final product at 1470.

Next a comparison of four one-iteration multiplication techniques: the Montgomery approach to Karatsuba (P. Montgomery, “Five, Six and Seven-Term Karatsuba-like Formulae”, IEEE Transactions on Computers, March 2005), the Paar and Weimerskirch approach, an embodiment and the schoolbook way. These techniques are compared in terms of the number of scalar multiplications each technique requires for representative operand sizes. From the numbers shown in FIG. 12 it is evident that an embodiment process outperforms all alternatives which are widely applicable to many different operand sizes. For some of the odd input sizes embodiments generate formulae for the input size minus 1 (which is even) and then use the Paar and Weimerskirch technique to generate products and subtractions for the additional input term.

The embodiment processes avoid the cost of recursion. The embodiments correlate between graph properties (i.e. vertices, edges and sub-graphs) and the Karatsuba-like terms of big number multiplication routines and these embodiments generate and use one iteration Karatsuba-like multiplication processes for any given operand size which are as fast as the recursive Karatsuba, without recursion. Embodiments are associated with the least possible number of ‘scalar’ multiplications. By scalar multiplications it is meant multiplications between ‘slices’ of big numbers or coefficients of polynomials. The embodiments can generate optimal, ‘one-iteration’, Karatsuba-like formulae using graphs.

Process 300 continues with block 330 where the product a b mod m is reduced using FMR.

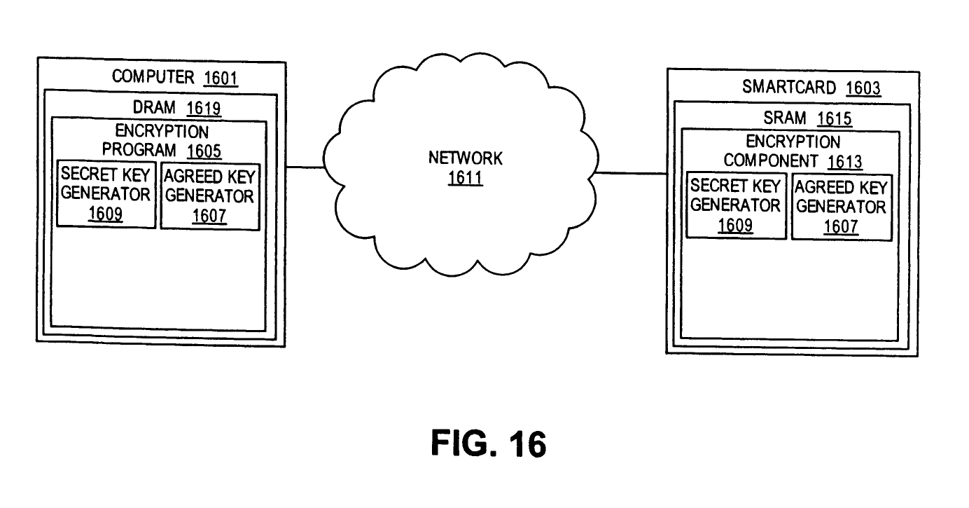

Embodiments of the present invention may be implemented using hardware, software, or a combination thereof and may be implemented in one or more computer systems or other processing systems. In one embodiment, the invention is directed toward one or more computer systems capable of carrying out the functionality described herein. In another embodiment, the invention is directed to a computing device. An example of a computing device 1601 is illustrated in FIG. 16. Various embodiments are described in terms of this example of device 1601, however other computer systems or computer architectures may be used.

FIG. 16 is a diagram of one embodiment of a system utilizing an optimized encryption system. The system may include two devices that are attempting to communicate with one another securely. Any type of devices capable of communication may utilize the system. For example, the system may include a first computer 1601 attempting to communicate securely with a smartcard 1603. Devices that use the optimized encryption system may include, computers, handheld devices, cellular phones, gaming consoles, wireless devices, smartcards and other similar devices. Any combination of these devices may communicate using the system.

Each device may include or execute an encryption program 1605. The encryption program 1605 may be a software application, firmware, an embedded program, hardware or similarly implemented program. The program may be stored in a non-volatile memory or storage device or may be hardwired. For example, a software encryption program 1605 may be stored in system memory 1619 during use and on a hard drive or similar non-volatile storage.

System memory may be local random access memory (RAM), static RAM (SRAM), dynamic RAM (DRAM), fast page mode DRAM (FPM DRAM), Extended Data Out DRAM (EDO DRAM), Burst EDO DRAM (BEDO DRAM), erasable programmable ROM (EPROM) also known as Flash memory, RDRAM® (Rambus® dynamic random access memory), SDRAM (synchronous dynamic random access memory), DDR (double data rate) SDRAM, DDRn (i.e., n=2, 3, 4, etc.), etc., and may also include a secondary memory (not shown).

The secondary memory may include, for example, a hard disk drive and/or a removable storage drive, representing a floppy disk drive, a magnetic tape drive, an optical disk drive, etc. The removable storage drive reads from and/or writes to a removable storage unit. The removable storage unit represents a floppy disk, magnetic tape, optical disk, etc., which is read by and written to by the removable storage drive. As will be appreciated, the removable storage unit may include a machine readable storage medium having stored therein computer software and/or data.

The encryption program 1605 may utilize any encryption protocol including SSL (secure sockets layer), IPsec, Station-to-Station and similar protocols. In one example embodiment, the encryption program may include a Diffie-Hellman key-exchange protocol, an RSA or modified RSA encryption/decryption algorithm.

The encryption program 1605 may include a secret key generator 1609 component that generates a secret key for a key-exchange protocol. The encryption program 1609 may also include an agreed key generator 1607 component. The agreed key generator 1607 may utilize the secret key from the encryption component 1613 of the device 1603 in communication with the computer 1601 running the encryption program 1605. Both the secret key generator 1609 and the agreed key generator 1607 may also utilize a public prime number and a public base or generator. The public prime and base or generator are shared between the two communicating devices (i.e., computer 1601 and smartcard 1603).

The encryption program may be used for communication with devices over a network 1611. The network 1611 may be a local area network (LAN), wide area network (WAN) or similar network. The network 1611 may utilize any communication medium or protocol. In one example embodiment, the network 1611 may be the Internet. In another embodiment, the devices may communicate over a direct link including wireless direct communications.

Device 1601 may also include a communications interface (not shown). The communications interface allows software and data to be transferred between computer 1601 and external devices (such as smartcard 1603). Examples of communications interfaces may include a modem, a network interface (such as an Ethernet card), a communications port, a PCMCIA (personal computer memory card international association) slot and card, a wireless LAN interface, etc. Software and data transferred via the communications interface are in the form of signals which may be electronic, electromagnetic, optical or other signals capable of being received by the communications interface. These signals are provided to the communications interface via a communications path (i.e., channel). The channel carries the signals and may be implemented using wire or cable, fiber optics, a phone line, a cellular phone link, a wireless link, and other communications channels.

In one example embodiment, an encryption component 1613 may be part of a smartcard 1603 or similar device. The encryption component 1613 may be software stored or embedded on a SRAM 1615, implemented in hardware or similarly implemented. The encryption component may include a secret key generator 1609 and agreed key generator 1607.

In alternative embodiments, the secondary memory may include other ways to allow computer programs or other instructions to be loaded into device 1601, for example, a removable storage unit and an interface. Examples may include a program cartridge and cartridge interface (such as that found in video game devices), a removable memory chip or card (such as an EPROM (erasable programmable read-only memory), PROM (programmable read-only memory), or flash memory) and associated socket, and other removable storage units and interfaces which allow software and data to be transferred from the removable storage unit to device 1601.

In this document, the term “computer program product” may refer to the removable storage units, and signals. These computer program products allow software to be provided to device 1601. Embodiments of the invention may be directed to such computer program products. Computer programs (also called computer control logic) are stored in memory 1619, and/or the secondary memory and/or in computer program products. Computer programs may also be received via the communications interface. Such computer programs, when executed, enable device 1601 to perform features of embodiments of the present invention as discussed herein. In particular, the computer programs, when executed, enable computer 1601 to perform the features of embodiments of the present invention. Such features may represents parts or the entire blocks Such features may represent parts or the entire blocks 110, 120, 130, 140, 310, 320 and 330 of FIGS. 1 and 3. Alternatively, such computer programs may represent controllers of computer 1601.

In an embodiment where the invention is implemented using software, the software may be stored in a computer program product and loaded into device 1601 using the removable storage drive, a hard drive or a communications interface. The control logic (software), when executed by computer 1601, causes computer 1601 to perform functions described herein.

Computer 1601 and smartcard 1603 may include a display (not shown) for displaying various graphical user interfaces (GUIs) and user displays. The display can be an analog electronic display, a digital electronic display a vacuum fluorescent (VF) display, a light emitting diode (LED) display, a plasma display (PDP), a liquid crystal display (LCD), a high performance addressing (HPA) display, a thin-film transistor (TFT) display, an organic LED (OLED) display, a heads-up display (HUD), etc.

In another embodiment, the invention is implemented primarily in hardware using, for example, hardware components such as application specific integrated circuits (ASICs) using hardware state machine(s) to perform the functions described herein. In yet another embodiment, the invention is implemented using a combination of both hardware and software.

In the description above, numerous specific details are set forth. However, it is understood that embodiments of the invention may be practiced without these specific details. For example, well-known equivalent components and elements may be substituted in place of those described herein, and similarly, well-known equivalent techniques may be substituted in place of the particular techniques disclosed. In other instances, well-known circuits, structures and techniques have not been shown in detail to avoid obscuring the understanding of this description.

Embodiments of the present disclosure described herein may be implemented in circuitry, which includes hardwired circuitry, digital circuitry, analog circuitry, programmable circuitry, and so forth. These embodiments may also be implemented in computer programs. Such computer programs may be coded in a high level procedural or object oriented programming language. The program(s), however, can be implemented in assembly or machine language if desired. The language may be compiled or interpreted. Additionally, these techniques may be used in a wide variety of networking environments. Such computer programs may be stored on a storage media or device (e.g., hard disk drive, floppy disk drive, read only memory (ROM), CD-ROM device, flash memory device, digital versatile disk (DVD), or other storage device) readable by a general or special purpose programmable processing system, for configuring and operating the processing system when the storage media or device is read by the processing system to perform the procedures described herein. Embodiments of the disclosure may also be considered to be implemented as a machine-readable or machine recordable storage medium, configured for use with a processing system, where the storage medium so configured causes the processing system to operate in a specific and predefined manner to perform the functions described herein.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

What is claimed is:

1. A method comprising:
encrypting input, the encrypting including:
converting a first factor and a second factor to carry bucket notation;
converting a third factor to the carry bucket notation;
determining a first product of the first converted factor and the second converted factor using a graphical process; and
reducing the first product modulus the third factor by flexible modular reduction (FMR).

2. The method of claim 1, wherein the graphical process includes:
determining a plurality of factors from input operands;
associating each factor of the plurality of factors with a level of a plurality of interconnected graphs in a hierarchy of graphs;
determining a plurality of generalized edges and a plurality of vertices from the plurality of interconnected graphs, the plurality of generalized edges including a plurality of spanning edges and a plurality of spanning planes;
determining a first plurality of products for the plurality of vertices;
determining a second plurality of products for the plurality of spanning edges and the plurality of spanning planes;
creating a plurality of coefficients from the first plurality of products and the second plurality of products; and
providing the plurality of coefficients to a multiplication portion of an encryption process.

3. The method of claim 1, wherein the determining the first product further comprises:
decomposing a generalized edge into the plurality of spanning edges and the plurality of spanning planes.

4. The method of claim 3, the creating the plurality of coefficients further includes using a plurality of diagonals determined from graphs associated with the first plurality of products and the second plurality of products, wherein the creating the plurality of coefficients is completed after a last generalized edge is processed.

5. The method of claim 4, wherein the creating of the plurality of coefficients includes:
performing a generate products process; and
performing a generate subtractions process.

6. The method of claim 1, wherein the second plurality of products is determined using the following equation
$${P}^{a} = \{ \begin{matrix}P ( \{ \begin{matrix}{v}_{( {i}_{0} ) … ( {i}_{{q}_{0}} ) … ( {i}_{{q}_{1}} ) … ( {i}_{{q}_{m - 1}} ) … ( {i}_{L - 1} )}^{( L - 1 )} , \\ {v}_{( {i}_{0} ) … ( {i}_{{q}_{0}}^{′} ) … ( {i}_{{q}_{1}} ) … ( {i}_{{q}_{m - 1}} ) … ( {i}_{L - 1} )}^{( L - 1 )} , \\ {v}_{( {i}_{0} ) … ( {i}_{{q}_{0}} ) … ( {i}_{{q}_{1}}^{′} ) … ( {i}_{{q}_{m - 1}} ) … ( {i}_{L - 1} )}^{( L - 1 )} , \\ {v}_{( {i}_{0} ) … ( {i}_{{q}_{0}}^{′} ) … ( {i}_{{q}_{1}}^{′} ) … ( {i}_{{q}_{m - 1}} ) … ( {i}_{L - 1} )}^{( L - 1 )} , … , \\ {v}_{( {i}_{0} ) … ( {i}_{{q}_{0}}^{′} ) … ( {i}_{{q}_{1}}^{′} ) … ( {i}_{{q}_{m - 1}}^{′} ) … ( {i}_{L - 1} )}^{( L - 1 )}\end{matrix} \} ) \text{:} \\ {i}_{j} ∈ [ o , {n}_{j} - 1 ] ∀ j ∈ [ 0 , L - 1 ] , \\ ( {i}_{{q}_{k}}^{′} ∈ [ 0 , {n}_{{q}_{k}} - 1 ] ⋀ {i}_{{q}_{k}} \neq {i}_{{q}_{k}}^{′} ) ∀ k ∈ [ 0 , m - 1 ] , \\ 0 \leq {q}_{0} \leq {q}_{1} \leq … \leq {q}_{m - 1} , m ∈ [ 0 , l ]\end{matrix} \} ,$$
where P^{a} represents the second plurality of products, v represents a vertex, L represents a level, q represents position and i represents a local index.

7. The method of claim 1, wherein the determining the product between the first converted factor and the second converted factor is performed with incremental modular multiplication.

8. An apparatus comprising:
a computer coupled to a memory, the computer to execute an encryption program in the memory, the encryption program including a carry bucket portion to convert notation of a first factor, a second factor and a third factor; an incremental modular multiplication portion to calculate a first product between a first converted factor and a second converted factor; a graphical multiplication portion to calculate a second product of the first converted factor and the second converted factor, and a flexible modular reduction (FMR) portion to reduce a third product between the first converted factor and the second converted factor modulus the third converted factor to generate encryption keys.

9. The apparatus of claim 8, the plurality of graphical multiplication portion includes:
an associating function to associate each factor of a plurality of factors generated from the input operands with a level of a plurality of interconnected graphs, the level is in a hierarchy;
a definition function to define a plurality of generalized edges and a plurality of vertices from the plurality of interconnected graphs, the plurality of generalized edges including a plurality of spanning edges and a plurality of spanning planes;
a multiplying function to determine a first plurality of products for the plurality of vertices and to determine a second plurality of products for the plurality of spanning edges and the plurality of spanning planes;
a decomposition function to perform subtractions of a periphery from graphs associated with the first plurality of products and the second plurality of products to determine a plurality of diagonals; and
a finalization function to generate the plurality of coefficients from the plurality of diagonals.

10. The apparatus of claim 9, wherein the interconnected graphs include a plurality of generalized graphs and a plurality of simple graphs, the plurality of simple graphs having a plurality of simple vertices and a plurality of simple edges.

11. The apparatus of claim 10, further comprising:
the multiplying function determines the second plurality of products using the following equation
$${P}^{a} = \{ \begin{matrix}P ( \{ \begin{matrix}{v}_{( {i}_{0} ) … ( {i}_{{q}_{0}} ) … ( {i}_{{q}_{1}} ) … ( {i}_{{q}_{m - 1}} ) … ( {i}_{L - 1} )}^{( L - 1 )} , \\ {v}_{( {i}_{0} ) … ( {i}_{{q}_{0}}^{′} ) … ( {i}_{{q}_{1}} ) … ( {i}_{{q}_{m - 1}} ) … ( {i}_{L - 1} )}^{( L - 1 )} , \\ {v}_{( {i}_{0} ) … ( {i}_{{q}_{0}} ) … ( {i}_{{q}_{1}}^{′} ) … ( {i}_{{q}_{m - 1}} ) … ( {i}_{L - 1} )}^{( L - 1 )} , \\ {v}_{( {i}_{0} ) … ( {i}_{{q}_{0}}^{′} ) … ( {i}_{{q}_{1}}^{′} ) … ( {i}_{{q}_{m - 1}} ) … ( {i}_{L - 1} )}^{( L - 1 )} , … , \\ {v}_{( {i}_{0} ) … ( {i}_{{q}_{0}}^{′} ) … ( {i}_{{q}_{1}}^{′} ) … ( {i}_{{q}_{m - 1}}^{′} ) … ( {i}_{L - 1} )}^{( L - 1 )}\end{matrix} \} ) \text{:} \\ {i}_{j} ∈ [ o , {n}_{j} - 1 ] ∀ j ∈ [ 0 , L - 1 ] , \\ ( {i}_{{q}_{k}}^{′} ∈ [ 0 , {n}_{{q}_{k}} - 1 ] ⋀ {i}_{{q}_{k}} \neq {i}_{{q}_{k}}^{′} ) ∀ k ∈ [ 0 , m - 1 ] , \\ 0 \leq {q}_{0} \leq {q}_{1} \leq … \leq {q}_{m - 1} , m ∈ [ 0 , l ]\end{matrix} \} , .$$
where P^{a} represents the second plurality of products, v represents a vertex, L represents a level, q represents position and i represents a local index.

12. A machine-accessible medium containing instructions that, when executed, cause a machine to:
perform an encryption program to encrypt input operands, the encryption program operates to:
convert a first factor and a second factor to carry bucket notation;
convert a third factor to the carry bucket notation;
determine a first product of the first converted factor and the second converted factor using a graphical process; and
reduce a third product of the first product modulus the third factor by flexible modular reduction (FMR).

13. The machine-accessible medium of claim 12, wherein the graphical process containing instructions that, when executed, cause a machine to:
determine a plurality of factors from an input operand;
associate each factor of the plurality of factors with a level of a plurality of interconnected graphs in a hierarchy of graphs;
determine a plurality of generalized edges and a plurality of vertices from the plurality of interconnected graphs, the plurality of generalized edges including a plurality of spanning edges and a plurality of spanning planes;
determine a first plurality of products for the plurality of vertices;
determine a second plurality of products for the plurality of spanning edges and the plurality of spanning planes;
create a plurality of coefficients from the first plurality of products and the second plurality of products, and
provide the plurality of coefficients to the encryption program for FMR.

14. The machine-accessible medium of claim 13, wherein the create the plurality of coefficients includes instructions that, when executed, cause a machine to:
perform a generate products process; and
perform a generate subtractions process.

15. The machine-accessible medium of claim 13, wherein the second plurality of products is determined using the following equation
$${P}^{a} = \{ \begin{matrix}P ( \{ \begin{matrix}{v}_{( {i}_{0} ) … ( {i}_{{q}_{0}} ) … ( {i}_{{q}_{1}} ) … ( {i}_{{q}_{m - 1}} ) … ( {i}_{L - 1} )}^{( L - 1 )} , \\ {v}_{( {i}_{0} ) … ( {i}_{{q}_{0}}^{′} ) … ( {i}_{{q}_{1}} ) … ( {i}_{{q}_{m - 1}} ) … ( {i}_{L - 1} )}^{( L - 1 )} , \\ {v}_{( {i}_{0} ) … ( {i}_{{q}_{0}} ) … ( {i}_{{q}_{1}}^{′} ) … ( {i}_{{q}_{m - 1}} ) … ( {i}_{L - 1} )}^{( L - 1 )} , \\ {v}_{( {i}_{0} ) … ( {i}_{{q}_{0}}^{′} ) … ( {i}_{{q}_{1}}^{′} ) … ( {i}_{{q}_{m - 1}} ) … ( {i}_{L - 1} )}^{( L - 1 )} , … , \\ {v}_{( {i}_{0} ) … ( {i}_{{q}_{0}}^{′} ) … ( {i}_{{q}_{1}}^{′} ) … ( {i}_{{q}_{m - 1}}^{′} ) … ( {i}_{L - 1} )}^{( L - 1 )}\end{matrix} \} ) \text{:} \\ {i}_{j} ∈ [ o , {n}_{j} - 1 ] ∀ j ∈ [ 0 , L - 1 ] , \\ ( {i}_{{q}_{k}}^{′} ∈ [ 0 , {n}_{{q}_{k}} - 1 ] ⋀ {i}_{{q}_{k}} \neq {i}_{{q}_{k}}^{′} ) ∀ k ∈ [ 0 , m - 1 ] , \\ 0 \leq {q}_{0} \leq {q}_{1} \leq … \leq {q}_{m - 1} , m ∈ [ 0 , l ]\end{matrix} \} ,$$
where P^{a} represents the second plurality of products, v represents a vertex, L represents a level, q represents position and i represents a local index.

16. The machine-accessible medium of claim 12, wherein the determine the first product is performed with incremental modular multiplication.

17. The machine-accessible medium of claim 12, wherein addition of two 128-bit numbers and multiplication of two 64-bit numbers are performed using the following assembly code:
```
#define add128(s2,s1,a2,a1)  \
_asm_{—}  \
  ( “addq %5, %1\n\t” \
    “adcq %4, %0” \
  : “=r” (s1) , “=r” (s2)  \
  : “0” (s1) , “1” (s2),  \
    “g” (a1) , “g” (a2)  \
  );
#define sub128(s2,s1,a2,a1)  \
_asm_{—}  \
  ( “subq %5, %1\n\t” \
    “sbbq %4, %0” \
  : “=r” (s1) , “=r” (s2)  \
  : “0” (s1) , “1” (s2),  \
    “g” (a1) , “g” (a2)  \
  );
/*
#define mul128(p2,p1,f1,f2)  \
_asm_{—}  \
  ( “mulq %3” \
  : “=d” (p1) , “=a” (p2)  \
  : “a” (f1) , “rm” (f2)  \
  );
.
```

18. A system comprising:
a first device coupled to a first memory, the first device to execute an encryption program in the first memory, the encryption program including a carry bucket portion to convert notation of a first factor, a second factor and a third factor; an incremental modular multiplication portion to calculate a first product between the first converted factor and the second converted factor; a graphical multiplication portion to calculate a second product of the first converted factor and the second converted factor and a flexible modular reduction (FMR) portion to reduce a third product between the first converted factor and the second converted factor modulus the third converted factor to generate a first encryption key and a second encryption key, the multiplication portion includes a plurality of graph based functions to generate a plurality of coefficients representing products returned from the multiplication portion to generate the first key and the second key;
a second device coupled to a second memory, the second device to execute the encryption program in the second memory,
wherein the first device and the second device transfer encrypted data to one another over a network.

19. The system of claim 18, the plurality of graph based functions includes:
an associating function to associate each factor of a plurality of factors generated from the input operands with a level of a plurality of interconnected graphs, the level is in a hierarchy;
a definition function to define a plurality of generalized edges and a plurality of vertices from the plurality of interconnected graphs, the plurality of generalized edges including a plurality of spanning edges and a plurality of spanning planes;
a multiplying function to determine a first plurality of products for the plurality of vertices and to determine a second plurality of products for the plurality of spanning edges and the plurality of spanning planes;
a decomposition function to perform subtractions of a periphery from graphs associated with the first plurality of products and the second plurality of products to determine a plurality of diagonals; and
a finalization function to generate the plurality of coefficients from the plurality of diagonals and to store the plurality of coefficients in the first memory.

20. The system of claim 18, wherein the first memory is a double data rate (DDRn) synchronous dynamic random access memory (SDRAM), wherein n is an integer equal to or greater than 2.

21. The system of claim 18, wherein the network is one of a wired and wireless.

22. The system of claim 18, wherein the second plurality of products is determined by the equation
$${P}^{a} = \{ \begin{matrix}P ( \{ \begin{matrix}{v}_{( {i}_{0} ) … ( {i}_{q 0} ) … ( {i}_{q 1} ) … ( {i}_{q m - 1} ) … ( {i}_{L - 1} )}^{( L - 1 )} , \\ {v}_{( {i}_{0} ) … ( {i}_{q 0}^{′} ) … ( {i}_{q 1} ) … ( {i}_{q m - 1} ) ... ( {i}_{L - 1} )}^{( L - 1 )} , \\ {v}_{( {i}_{0} ) … ( {i}_{q 0} ) … ( {i}_{q 1}^{′} ) … ( {i}_{q m - 1} ) … ( {i}_{L - 1} )}^{( L - 1 )} , \\ {v}_{( {i}_{0} ) … ( {i}_{q 0}^{′} ) … ( {i}_{q 1}^{′} ) … ( {i}_{q m - 1} ) … ( {i}_{L - 1} )}^{( L - 1 )} , … , \\ {v}_{( {i}_{0} ) … ( {i}_{q 0} ) … ( {i}_{q 1} ) … ( {i}_{q m - 1} ) … ( {i}_{L - 1} )}^{( L - 1 )}\end{matrix} \} ) \text{:} \\ {i}_{j} ∈ [ o , {n}_{j} - 1 ] ∀ j ∈ [ 0 , L - 1 ] , \\ ( {i}_{{q}_{k}}^{′} ∈ [ 0 , {n}_{{q}_{k}} - 1 ] ⋀ {i}_{{q}_{k}} \neq {i}_{{q}_{k}}^{′} ) ∀ k ∈ [ 0 , m - 1 ] , \\ 0 \leq {q}_{0} \leq {q}_{1} \leq … \leq {q}_{m - 1} , m ∈ [ 0 , L ]\end{matrix} \} ,$$
where P^{a} represents the second plurality of products, v represents a vertex, L represents a level, q represents position and i represents a local index.

23. The system of claim 18, wherein the second device is one of a smartcard, a personal digital assistant (PDA), a cellular telephone and a gaming console.
